(19) United States
(12) Patent Application Publication
(10) Pub. No.: US 2008/0204708 A1
(43) Pub. Date: Aug. 28, 2008

(54) Functionalised Surface Sensing Apparatus and Methods

(75) Inventor: Andrew Mark Shaw, Exeter (GB)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: EVANESCO LTD, Newton Abbot (GB)

(21) Appl. No.: 10/593,105

(22) PCT Filed: Mar. 15, 2005
(86) PCT No.: PCT/GB2005/050034

§ 371 Date: May 6, 2008

(51) Int. Cl. G01N 1/00; G01N 21/55; G02B 6/00

(52) U.S. Cl. 356/36; 356/445; 385/12

(57) ABSTRACT

We describe an evanescent wave cavity-based optical sensor. The sensor comprises an optical cavity formed by a pair of highly reflective surfaces and including a totally internally reflecting (TIR) surface generating an evanescent wave to provide a sensing function. The TIR surface is provided with a functionalising material over at least part of said TIR surface such that said evanescent wave interacts with said material, and whereby an interaction between said functionalising material and a target to be sensed is detectable as a change in absorption of said evanescent wave. The technique is extremely sensitive and thus in a gas sensor the evanescent wave TIR surface is provided with a solvating medium, and in other configurations a partition or atrium is provided for the evanescent wave sensing region.

This invention is generally concerned with sensing apparatus and methods, more particularly apparatus and methods for sensing techniques based upon cavity ring-down spectroscopy (CRDS), in particular evanescent-wave based techniques. These will be described with particular reference to functionalising a sensing surface with the aim of increasing specificity and/or sensitivity.

Cavity Ring-Down Spectroscopy is known as a high sensitivity technique for analysis of molecules in the gas phase (see, for example, G. Berden, R. Peeters and G. Meijer, Int. Rev. Phys. Chem., 19, (2000) 565, P. Zalicki and R. N. Zare, J. Chem. Phys. 102 (1995) 2708, M. D. Levinson, B. A. Paldus, T. G. Spence, C. C. Harb, J. S. Harris and R. N. Zare, Chem. Phys. Lett. 290 (1998) 335, B. A. Paldus, C. C. Harb, T. G. Spence, B. Wilkie, J. Xie, J. S. Harris and R. N. Zare, J. App. Phys. 83 (1998) 3991. D. Romanini, A. A. Kachanov and F. Stoeckel, Chem. Phys. Lett. 270 (1997) 538). The CRDS technique can readily detect a change in molecular absorption coefficient of 10⁻⁶ cm⁻¹, with the additional advantage of not requiring calibration of the sensor at the point of measurement since the technique is able to determine an absolute molecular concentration based upon known molecular absorbance at the wavelength or wavelengths of interest. Although the acronym CRDS makes reference to spectroscopy in many cases measurements are made at a single wavelength rather than over a range of wavelengths.

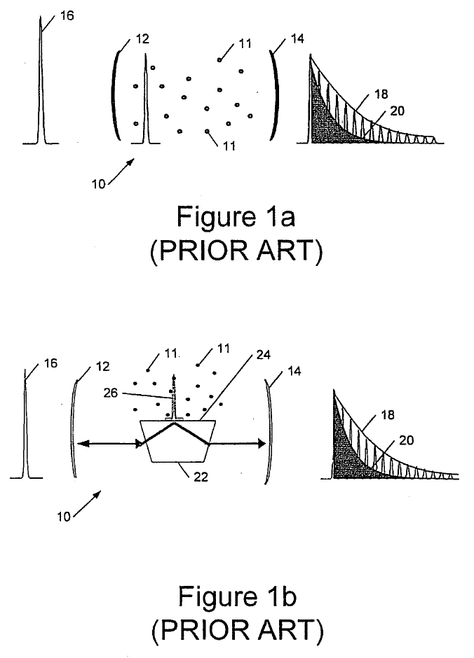

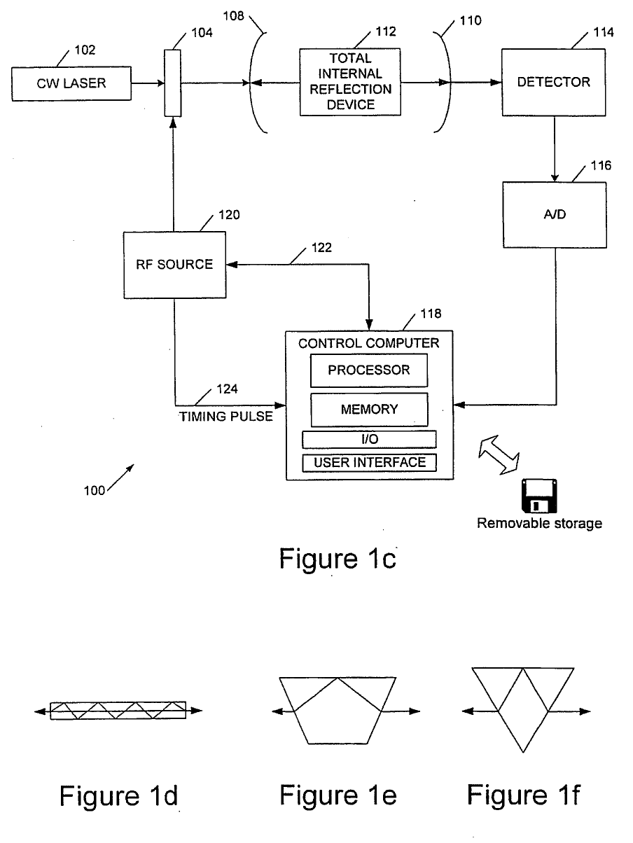

FIG. 1a, which shows a cavity 10 of a CRDS device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, τ. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δτ, is a function of the strength of absorption of the molecule at the frequency, v, of interest α(v) (the molecular extinction coefficient) and of the concentration per unit length, lₛ, of the absorbing species and is given by equation 1 below.

Δτ=tᵣ/{2(1−R)+α(v)lₛ} (Equation 1)

where R is the reflectivity of each of mirrors 12, 14 and tᵣ is the round trip time of the cavity, tᵣ=c/2L where c is the speed of light and L is the length of the cavity. Since the molecular absorption coefficient is a property of the target molecule, once Δτ has been measured the concentration of molecules within the cavity can be determined without the need for calibration.

It will be appreciated that to employ equation 1 measurements of the mirror reflectivities, the molecular absorption (or extinction) coefficient, the cavity length and (where different) the sample lengths are necessary but these may be determined in advance of any particular measurement, for example, during initial set up of a CRDS machine. Likewise since the decay times are generally relatively short, of the order of tens of nanoseconds, a timing calibration may also be needed, although again this may be performed when the apparatus is initially set up.

It will be further appreciated that to achieve a high sensitivity the reflectivities of mirrors 12, 14 should be high (whilst still permitting a detectable level of light to leak out) and typically R equals 0.9999 to provide of the order of 10⁴ bounces. If the total losses in the cavity are around 1% there will only be 3 or 4 bounces and consequently the sensitivity of the apparatus is very much reduced; in practical terms it is desirable to have total losses less than 0.25%, corresponding to around 200 bounces during decay time τ, or approximately 1000 bounces during ring down of the entire cavity.

One problem with CRDS is that the technique is only suitable for sensing molecules that are introduced into the cavity in a gas since if a liquid or solid is introduced into the cavity losses become very large and the technique fails. To address this problem so-called evanescent wave CRDS (e-CRDS) can be employed, as described in the Applicant's co-pending UK patent application no. 0302174.8 filed 30 Jan. 2003. Background prior art relating to e-CRDS can be found in U.S. Pat. No. 5,943,136, U.S. Pat. No. 5,835,231, U.S. Pat. No. 5,986,768, EP1195582A, A. J. Hallock et al. “Use of Broadband, Continuous-Wave diode Lasers in Cavity Ring-Down Spectroscopy for Liquid Samples”, Applied Spectroscopy, 57(5), 2003, 571-573, and D. Romanini et al, “CW cavity ring down spectroscopy”, Chem. Phys. Lett. 264 (1997) 316-322.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θ_{c}, where sin θ_{c} is equal to n₂/n₁ where n₂ is the refracted index of the medium outside the prism and n₁ is the refractive index of the material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but it's intensity decreases exponentially with distance from the surface, typically over a distance of the order of the a wavelength. The depth at which the intensity of the e-wave falls to 1/e (where e=2.718) of it's initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by the e-wave resulting from the total internal reflection at the surface.

### SUMMARY OF THE INVENTION

Although the sensitivity of CRDS apparatus, in particular e-CRDS apparatus, is very high it is nonetheless desirable to provide further improvements in sensors based upon this general principle. The idea of using an indicator agent which changes its refractive index or absorption in the presence of a particular chemical or protein is mentioned in EP1195582A, but without any practical details of how such an approach might be implemented. The present applicants have found that, in practice, such an approach does not work. Further investigations revealed an explanation and solution. Simply coating an indicator agent onto a fibre generally results in an amorphous, multilayer structure and the reason that this is ineffective is apparently related to dominant light scattering effects within such a structure.

The applicants have also recognised that these effects can be reduced to a level at which they are not significantly deleterious by employing techniques which aim to ensure that feature sizes of a functionalising structure (or more generally feature sizes of the overall surface average roughness) at the evanescent wave interface are substantially below a threshold size determined by the operating wavelength of the system, generally less than 3 microns, preferably less than 2 microns or 1 micron. The applicants have further found that this can be achieved by depositing the functionalising material as monolayer or fraction of a monolayer. Preferably therefore the material is tethered or attached to the evanescent wave surface, for example in the case of a silica surface by silanol groups, which facilitates the formation of such a structure.

According to a first aspect of the present invention there is therefore provided an evanescent wave cavity-based optical sensor, the sensor comprising: an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function; a light source to inject light into said cavity; and a detector to detect a light level within said cavity; and wherein said TIR surface is provided with a functionalising material over at least part of said TIR surface such that said evanescent wave interacts with said material; whereby an interaction between said functionalising material and a target to be sensed is detectable as a change in absorption of said evanescent wave. The sensed target may be biological or non-biological, living or non-living, examples including elements, ions, small and large molecules, groups of molecules, and bacteria and viruses. The target may comprise a single substance, species or entity or a group of substances, species or entities.

Functionalising the TIR surface, for example by depositing onto it a material which has a selective response to the target or target group facilitates a more specific and selective response from the sensor, which is useful because of the very high sensitivity of the technique. In some instances this already high sensitivity may even be increased. Broadly speaking the evanescent wave at the TIR surface is modified by the functionalising material, giving rise to a change in the change in the cavity characteristics, in particular the ring-down (or up) time, when a target is attached, bound or otherwise adjacent the functionalising material, which in preferred embodiments comprises a chromophore.

Thus in another aspect the invention provides an evanescent wave cavity ring-down sensor comprising: a ring-down optical cavity including an attenuated total-internal-reflection (ATIR) based sensing device for sensing a substance modifying a ring-down characteristic of the cavity; a continuous wave light source for exciting said cavity; and a detector for monitoring said ring-down characteristic; and wherein said sensing device includes an ATIR interface to which is attached a material which has a selective response to a target such that an evanescent wave at said interface is modified by said target to modify said cavity ring-down characteristic.

Preferably the TIR surface or interface has substantially no features with a dimension perpendicular to the surface or interface of greater than 3 μm, more preferably 1 μm. Such features may comprise or consist of peaks or height discontinuities above a local mean plane (for example defined over a lateral distance of up to 10 μm from the peak). Alternatively a similar constraint may be expressed in terms of a maximum average (eg root mean square) surface roughness, which is preferably less than twice an operating wavelength of the system, more preferably less than a wavelength. Thus in embodiments additionally (or instead of the absolute distance limitation mentioned above), the light source is configured to inject light at an operating wavelength and the TIR surface or interface has substantially no features with a dimension perpendicular to the surface or interface of greater than twice this wavelength, and preferably no features greater than a single said operating wavelength. In functional terms preferably light scattering at the interface (at the operating wavelength or wavelengths) is substantially inhibited, at least sufficient for cavity-ring down (with a plurality of passes of the cavity) to take place. Thus preferably optical loss from the cavity (when the target is substantially absent) at the operating wavelength or wavelengths is less than 1%, more preferably less than 0.1% or 0.01%.

In other embodiments the TIR surface or interface has a mean thickness of less than, in order of preference, 3 μm, 1 μm, 500 nm, 200 nm, 100 nm. Broadly it is preferred to work in the near field, that is sensing at a distance from the TIR surface or interface of less than the evanescent wave penetration depth (at the wavelength or wavelengths of interest), typically implying a mean film thickness of between 50 nm and 100 nm. Likewise it is preferable that the mean surface roughness is less than the evanescent wave penetration depth, that is less than, in order of preference 500 nm, 200 nm, 100 nm. In functional terms structure of the layer of functionalising material (at least in a direction perpendicular to the surface, and preferably also in a lateral direction ie. substantially parallel to the surface) should be is on such a scale that Mie rather than Rayleigh scattering dominates.

The achievement of these ends is facilitated by use of a material incorporating a molecular tether or link to attach the material to the TIR surface or interface. Preferably the functionalising material comprises a monolayer or less on this surface or interface; in some preferred embodiments the functionalising material comprises less than 10⁻¹, 10⁻², 10⁻³, 10⁻⁴, or 10⁻⁵ of a monolayer (for example taking the form of islands of monolayer). Where there is only partial surface or interface coverage preferably the uncovered portions are passivated.

As previously mentioned, in preferred embodiments the functionalising material comprises a molecular material attached to the TIR surface or interface, in particular by means of a molecular tether or link but alternative deposition techniques may also be employed. The functionalising material may comprise a molecular material, preferably including a chromophore with an absorption at the wavelength of the light within the cavity, for example a host for a guest species or ligand. The material may include a molecular tether, link or chain for attaching it to the surface or interface; where the surface/interface comprises silica the tether may be attached by means of a Si—O—Si bond. Where the functionalising material only partially covers the (TIR) surface or interface parts of the surface which are not fully covered can become charged, and can act as an affinity surface, and by controlling the surface coverage the charged properties of the surface/interface can be modified.

Where a protein or a monoclonal (or polyclonal) antibody is used as the functionalising material, there may be a natural chromophore or a chromophore may be tethered to the protein or antibody to allow it to be seen at the operating wavelengths of the sensor. For example an antibody-based oestrogen sensor may be constructed, in embodiments for real time monitoring, say in a river. An antibody may be deposited by many known techniques. Another example functionalising material is haemoglobin, which naturally absorbs in the blue and generally forms a good quality film (W. B. Martin, S. Mirov, D. Marydtk and A. M. Shaw J. Biomed. Optics, in press).

In some preferred embodiments the functionalising material is provided as a thin film with two components, a first component, preferably comprising a chromophore, and a second component providing an affinity for the sample or target. Thus in embodiments the functionalising material comprises a thin film with a low optical density of chromophore but a higher concentration of a molecule that has a particular affinity for the target. The affinity molecule improves attraction of the target to the sensor surface, optionally with some following chemistry, before the either the target molecule or a product from the film chemistry is detected by the chromophore.

A chromophore-comprising component of the functionalising material may only partially cover the evanescent wave sensing (TIR) surface or interface. A portion of the surface or interface which is not covered by the chromophore-comprising component of the functionalising material may be passivated or neutralised, or it may have a positive or negative charge facilitating attraction of a target. Additionally or alternatively a portion of the surface or interface which is not covered by the chromophore-comprising component of the functionalising material may be provided with a non-polar or fatty molecule (or part of a molecule), such as a C₁₀ carbon chain attached to a silanol species, (in effect replacing methane with dodecyl in a trimethoxymethylsilane described later). The molecule is thus tethered, in this example by its “silicon” end, leaving the fatty, hydrophobic chain projecting from the surface, facilitating the attraction of a target with at least a non-polar/hydrophobic portion. In a similar way by replacing, say, the methane part with, for example, an amino propyl or octyl species can provide a polar or hydrophilic interface part, facilitating the attraction of a target with at least a polar or hydrophilic portion. Thus additionally or alternatively a portion of the surface or interface which is not covered by the chromophore-comprising component of the functionalising material may be provided with a polar, hydrophilic or amphiphilic molecule (or part of a molecule).

In some preferred embodiments the sensing device comprises a fibre optic (FO) cable. This facilitates practical applications of the technology, in particular outside a lab environment, and the fabrication of inexpensive or even disposable sensing devices, for example for pregnancy or sugar tests. The modification may comprise removing a portion of the FO surface and/or tapering the FO; by controlling the degree of modification/taper the evanescent field may also be controlled and hence adapted to a particular sensing function or application.

The invention also provides an optical cavity including a TIR surface or interface as described above. The skilled person will understand that such the optical cavity may be provided without one or both mirrors since these may be provided by the cavity sensing apparatus within which the TIR surface or interface is to operate.

Thus in a further aspect the invention provides a sensor for a cavity of an evanescent-wave cavity ring down device, the sensor comprising a fibre optic cable having a core configured to guide light down the fibre surrounded by an outer cladding of lower refractive index than the core, wherein a sensing portion of the fibre optic cable is configured have a reduced thickness cladding provided with a functionalising material which has a selective response to a target such that an evanescent wave from said guided light interacts with said material and is modified by the presence of said target.

The skilled person will recognise that the various preferred features described above with reference to cavity sensing apparatus may similarly be included in this fibre optic-based sensor.

In general, it is preferable that the evanescent wave penetration depth is adjusted, for example by adjusting the angle of incidence (for a prism) or the taper profile or length (for a tapered fibre optic), to limit losses via the evanescent wave sufficiently to provide a plurality of optical passes within the cavity. In particular the taper of a fibre optic sensor may be adjusted in length and/or minimum waist diameter to modify the level of interaction with the functionalising material, thus enabling the response of the sensor (and functionalising layer thickness/coverage) to be tuned according to the application. For example some sensors are substantially irreversible and provide a cumulative response to the target, an example being a Cl₂ sensor in which the reagent is simply bleached without recovery. Thus an interaction with a relatively high layer thickness can facilitate monitoring a higher target sample concentration, whereas for sensitive sensors in which only a very small level of the sample/target is to be sensed monolayer or sub-monolayer coverage may be employed and the evanescent wave interaction modified accordingly. In other cases, for example some pH sensors, the binding of a target molecule onto a host molecule on the surface is substantially reversible, although the binding kinetics and properties of the surface will generally control the rate of response.

The functionalising material may be deposited onto the tapered fibre by dipping the fibre into/through a bath containing the materials, and this process can be adjusted depending upon the taper profile with, for example, a shorter dip for a thinner profile and a longer dip for a fatter profile. The surface characteristics of the fibre also affect this deposition process and, in another aspect the invention provides a method of adjusting the surface coverage of functionalising material on a tapered fibre (or other sensing surface/interface) by controlling the pH of a bath or solution into which the fibre (or other surface/interface) is dipped or from which the material is deposited in some other way. In embodiments this enables adjustment/control of the surface charge. For example with a silica interface low pH favours binding to the Q3 silanol sites whereas high pH tends towards binding to all Q2 and Q3. Q3 is about 27% of the sites on the surface and so has a natural restriction to the degree of coverage ie a low pH deposition will allow only 27% of the surface to be covered.

In a further aspect, however, (which may be combined with the preceding aspect) the invention provides a method in which the surface charge may be adjusted without substantially changing the bulk pH by selecting an acid and/or base (for the bath/solution), in particular selecting the strength of the acid or base, to adjust a degree of protonation of a surface on which the functionalising material is to be deposited.

In another aspect the invention provides an optical cavity-based sensing device comprising: an optical cavity absorption sensor comprising an optical cavity formed by a pair of reflecting surfaces; a light source for providing light to couple into said cavity; and a light detector for detecting a level of light escaping from said cavity; wherein said optical cavity includes a sensing device comprising a functionalised optical interface, said optical interface being provided with a material which has a selective response to a target; and wherein the functionalising optical interface is configured to substantially inhibit scatter of said light.

In a further aspect the invention provides an optical cavity-based gas-phase sensing device comprising: an optical cavity absorption sensor comprising an optical cavity formed by a pair of reflecting surfaces; a light source for providing light to couple into said cavity; and a light detector for detecting a level of light escaping from said cavity; wherein said optical cavity includes a sensing device comprising a functionalised optical interface, said optical interface being provided with a solvating medium to convert a gas-phase target to a solution at said interface.

The invention also provides an evanescent wave optical sensing device, the device having a light input and a light output and being configured to provide an optical path between said light input and said light output, said optical path including a totally internally reflecting (TIR) optical interface for attenuated TIR-based sensing, and wherein said TIR interface is provided with a functionalising material which has a selective response to a target such that an evanescent wave at said interface is modified by the presence of said target; and wherein a portion of the interface bearing the functionalising material has substantially no features with a dimension perpendicular to the interface of greater than 3 μm, more preferably 1 μm.

Depending upon the absorbance only one or two passes may be necessary to provide a detectable signal; in embodiments the light input and light output may substantially correspond.

In the sensing systems described above and below polarisation maintaining fibre may advantageously be employed. This facilitates, for example measurement in the plane of the polarization and comparison of the result with another measurement, for example in a different plane or with a measurement from an un-polarised cavity. This may provide, for example, a measure of a dichroic ratio, which may be employed, for example, in the determination of a molecular orientation such as which way up a molecule is bound to the surface.

One useful feature of temporal profiling of a sensed change determined by monitoring bounce-by-bounce pulse profiles (which may comprise punctuated monitoring, for example every nth pulse) is the effective localisation of the sample. In the gas phase the sample is everywhere so that sample close to the mirror gets two pulse very close followed by a long gap as the pulses make the trip to the first mirror and back again. This can result in problems as the sample may be excited by the first pulse and then re-interrogated by the second after a very short time interval, in a pump-probe type experiment. The sequence pump-t1-probe-delay-t2-pump-t1-probe is then variable at each place in the cavity. In the (e-)CRDS variation the sample is located at one (or more) particular place (or places) in the cavity. For example if this were the middle the pump-t1-probe-delay-t2-pump-t1-probe sequence would be controlled at ½ tr. As the position is moved within the cavity (eg by selecting different taper positions) the timescales t1 and t2 can be tuned for a specific photochemical process

A further refinement is a pump λ1 and probe λ2 configuration where λ1 and λ2 are different. For example λ1 could be in the blue so that it does not bounce in the cavity because the mirrors do not reflect in the blue but the probe pulse at λ2 is at a wavelength at which the mirrors do reflect and can therefore can make multiple probes. This gives a pump-probe-probe-probe-probe sequence with controlled pump and probe time based on the position of the e-field and hence sample within the cavity. A condition may be placed on the pulses that they are shorter than the tr so that the sample only sees substantially one pulse at a time and not at any significant level, say, the top of one pulse and the tail of the preceding pulse at the same time. This can facilitate the interrogation by limiting to one discrete wavelength or a few discrete wavelengths.

The invention further provides an optical charge/capacitance sensor for providing an optical signal responsive to charge and/or capacitance at an optical interface, said sensor comprising a light input and a light output and being configured to provide an optical path between said light input and said light output, said optical path including a totally internally reflecting (TIR) optical interface for attenuated TIR-based sensing, said TIR interface being treated such that a change in charge and/or capacitance at said interface causes a change in absorbance of light travelling between said light input and said light output.

Broadly speaking an affinity sensor according to an embodiment of the present invention detects a physicochemical change accompanying complex formation, in particular a change resulting in a change in light absorption within the cavity. However in preferred embodiments the sensor is refreshable so that once a measurement has been made an initial state can be at least partially regenerated initial state, for example by splitting off a target or the complex.

Thus the invention also provides a method of refreshing an interface to which is attached a material which has a selective response to a target, the method comprising: providing said interface with a photoelectron generator; and illuminating said photoelectron generator to release electrons to refresh said interface.

Similarly the invention provides a sensing device including an interface to which is attached a material which has a selective response to a target, and wherein said interface is further provided with a photoelectron generator to assist in refreshing said interface.

The photoelectron generator may comprise a metallic material or metal oxide such as titanium (di)oxide or a (semi)conducting polymer or biopolymer.

The invention also provides a sensing device including an interface to which is attached a material which has a selective response to a target, said device further comprising a partition configured to allow selective transport of entities via said partition to and/or from said interface.

The partition is preferably three-dimensional and may define a chamber or atrium around the sensing surface or interface. Preferably said entities are for refreshing said interface; preferably they comprise charged species.

Further features and advantages of some implementations of the above described systems will now be described. These have previously been set out in detail in the Applicant's co-pending International patent application number PCT/GB2004/000020, filed on 8 Jan. 2004, the entire contents of which are hereby incorporated by reference.

The sensitivity of an e-CRDS or a conventional CRDS-based device may be improved by taking a succession of measurements and averaging the results. However the frequency at which such a succession of measurements can be made is limited by the maximum pulse rate of the pulsed laser employed for injecting light into the cavity. This limitation can be addressed by employing a continuous wave (CW) laser such as a laser diode, since such lasers can be switched on and off faster than a pulsed laser's maximum pulse repetition rate. However, there are significant difficulties associated with coupling light from a CW laser into the cavity, particularly where a so-called stable cavity is employed, typically comprising planar or concave mirrors.

We have previously described, in UK patent application no. 0302174.8, how these difficulties may be addressed by employing a cavity ring-down sensor with a light source, such as a continuous wave laser, of a power and bandwidth sufficient to overcome losses within the cavity and couple energy into at least two modes of oscillation (either transverse or longitudinal) of the cavity. Preferably the light source is operable as a substantially continuous source and has a bandwidth sufficient to provide at least a half maximum power output across a range of frequencies equal to at least a free spectral range of the cavity. This facilitates coupling of light into the cavity even when modes of the light source and cavity are not exactly aligned. The light source may be shuttered or electronically controlled so that the excitation may be cut off to allow measurement of a ring-down decay curve. To facilitate accurate measurement of a ring-down time the CW light source output is preferably cut off in less than 100 ns, more preferably less than 50 ns. When driven with a CW laser the cavity preferably has a length of greater than 0.5 m more preferably greater than 1.0 m because a longer cavity results in closer spaced longitudinal modes.

In general the evanescent wave may either sense a substance directly or may mediate a sensing interaction through sensing a substance or a property of a material. The detector detects a change in light level in the cavity resulting from absorption of the evanescent wave, and whilst in practice this is almost always performed by measuring a ring-down characteristic of the cavity, in principle a ring-up characteristic of a cavity could additionally or alternatively be monitored. As the skilled person will appreciate the reflecting surfaces of the cavity are optical surfaces generally characterized by a change in reflective index, and may physically comprise internal or external surfaces.

The number of passes light makes through the cavity depends upon the Q of the cavity which, for most (but not all) applications, should be as high as possible. Although the cavity ring-down is responsive to absorption in the cavity this absorption may either be direct absorption by a sensed material or may be a consequence of some other physical effect, for example surface, localized or particle plasmon resonance or measured property.

We have also previously described, in UK patent application no. 0302174.8, how in a preferred embodiment the cavity comprises a fibre optic cable with reflective ends. In embodiments this provides a number of advantages including physical and optical robustness, physically small size, durability, ease of manufacture, and flexibility, enabling use of such a sensor in a wide range of non lab-based applications.

To provide an evanescent-wave sensor a fibre optic cable may be modified to provide access to an evanescent field of light guided within the cable. The invention provides a fibre-optic sensor of this sort, for example for use in evanescent wave cavity ring-down device of the general type described above.

A fibre optic cable typically comprises a core configured to guide light down the fibre surrounded by an outer cladding of lower refractive index than the core. A sensing portion of the fibre optic cable may be configured have a reduced thickness cladding over part or all of the circumference of the fibre such that an evanescent wave from said guided light is accessible for sensing. By reducing the thickness of the cladding, in embodiments to expose the core, the evanescent wave can interact directly with a sensed material or substance or attenuation of light within the cavity via absorption of the evanescent wave can be indirectly modified, for example in an SPR-based sensor by modifying the interaction of a surface plasmon excited in overlying conductive material with the evanescent wave (a shift or modification of a plasmon resonance changing the absorption).

One, or preferably both ends of the fibre optic cable may be provided with a highly reflecting surface such as a Bragg stack. The fibre optic cable thus provides a stable cavity, that is guided light confined within the cable will retrace its path many times. Preferably the fibre optic cable (and hence cavity) has a length of at least a length of 0.5 m, and more preferably of at least 1.0 m, to facilitate coupling of a continuous wave laser to the fibre optic sensor, as described above. The sensor may be coupled to a fibre optic extension and, optionally, may include an optical fibre amplifier; such an amplifier may be incorporated within the cavity.

The fibre optic cable is preferably a step index fibre, although a graded index fibre may also be used, and may comprise a single mode or polarization-maintaining or high birefringence fibre. Preferably the sensing portion of the cable has a loss of less than 1%, more preferably less than 0.5%, most preferably less than 0.25%, so that the cavity has a relatively high Q and consequently a high sensitivity. Where the sensor is to be used in a liquid the core of the fibre should have a greater refractive index than that of the liquid in which it is to be immersed in order to restrict losses from the cavity. The sensor may be attached to a Y-coupling device to facilitate single-ended use, for example inside a human or animal body.

The skilled person will understand that features and aspects of the above described sensors and apparatus may be combined.

In all the above aspects of the invention references to optical components and to light includes components for and light of non-visible wavelengths such as infrared and other light.

These and other aspects of the present invention will now be further described, by way of example only, with reference to the accompanying figures:

FIGS. 1a-1f show, respectively, an operating principle of a CRDS-type system, an operating principle of an e-CRDS-type system, a block diagram of a continuous wave e-CRDS system, and first, second and third total internal reflection devices for a CW e-CRDS system;

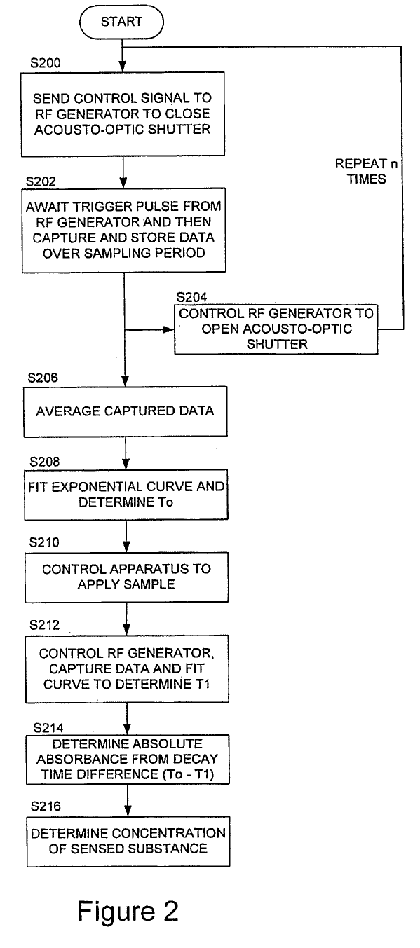

FIG. 2 shows a flow diagram illustrating operation of the system of FIG. 1c;

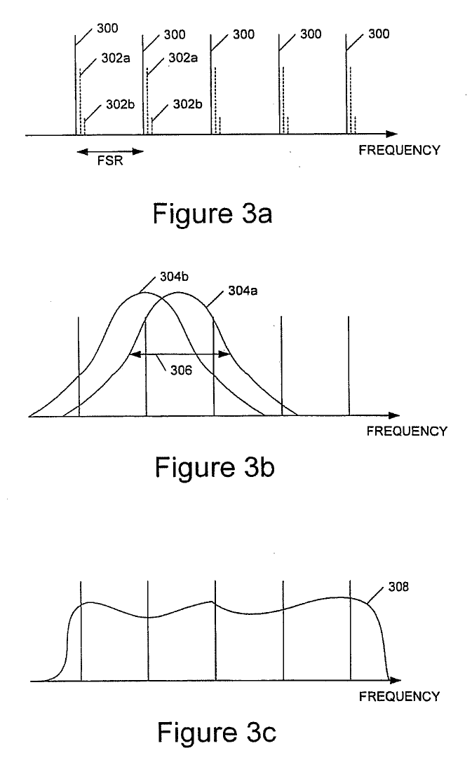

FIGS. 3a -3c show, respectively, cavity oscillation modes for the system of FIG. 1c, a first spectrum of a CW laser for use with the system of FIG. 1c, and a second CW laser spectrum for use with the system of FIG. 1c;

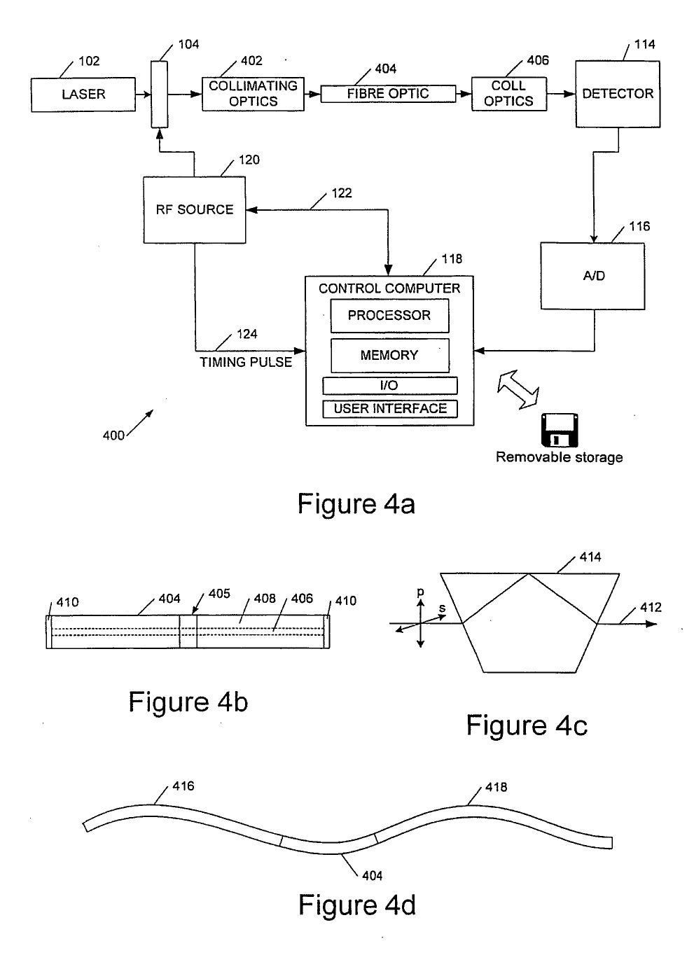

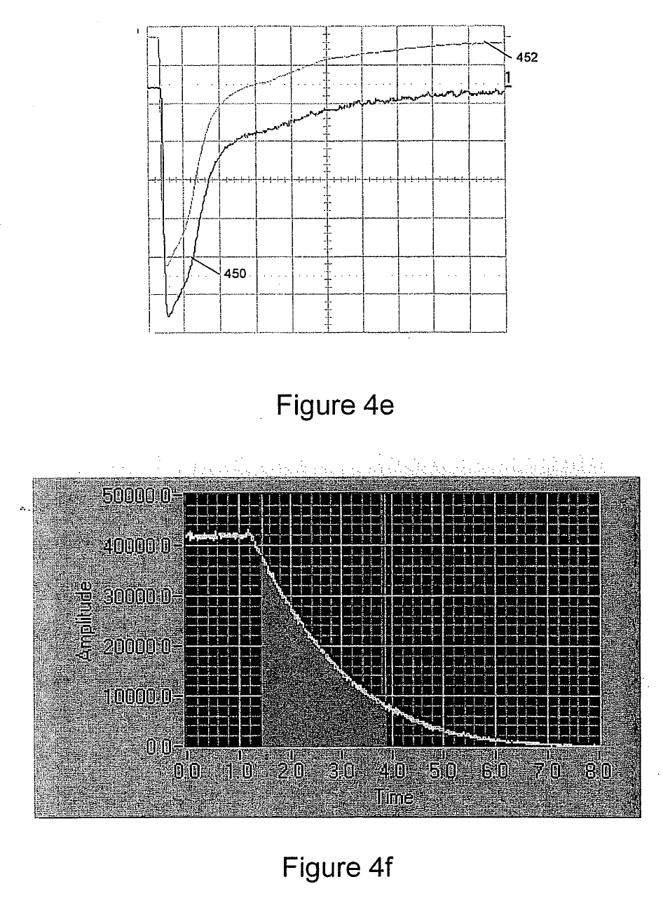

FIGS. 4a -4f show, respectively, a fibre optic-based e-CRDS system, a fibre optic cable for the system of FIG. 4a, an illustration of the effect of polarization in a total internal reflection device, a fibre optic cavity-based sensor, and examples of fibre optic cavity ring-down profiles;

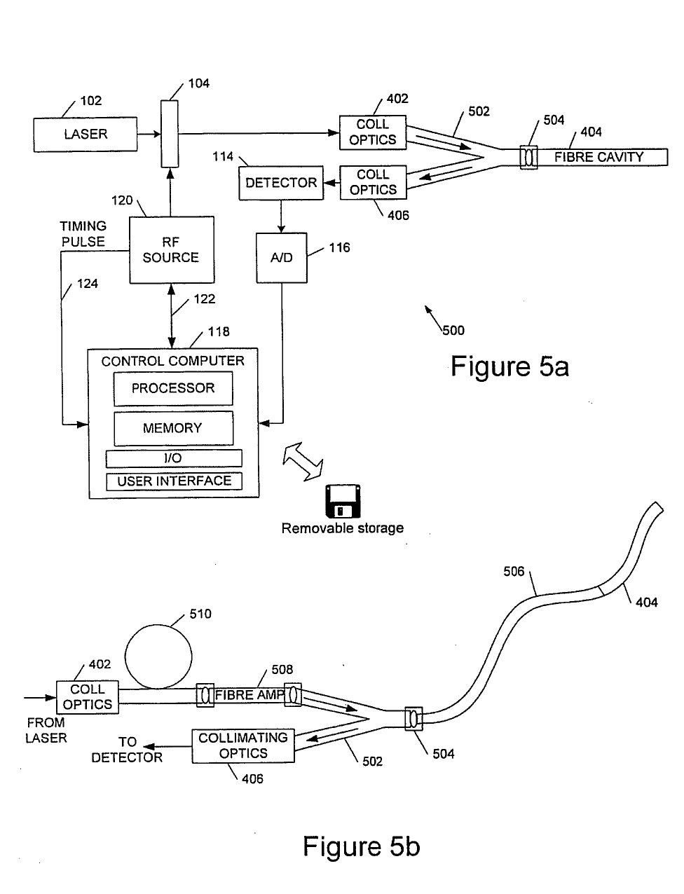

FIGS. 5a and 5b show, respectively, a second fibre optic based e-CRDS device, and a variant of this device;

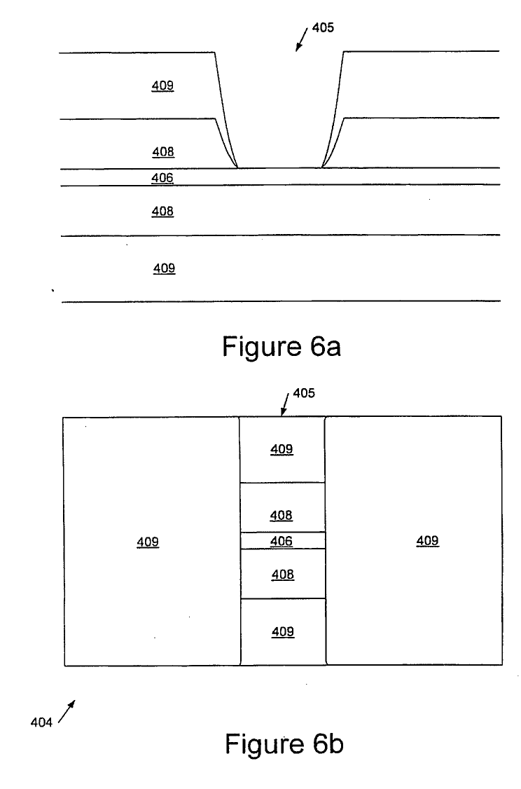

FIGS. 6a and 6b show, respectively, a cross sectional view and a view from above of a sensor portion of a fibre optic cavity;

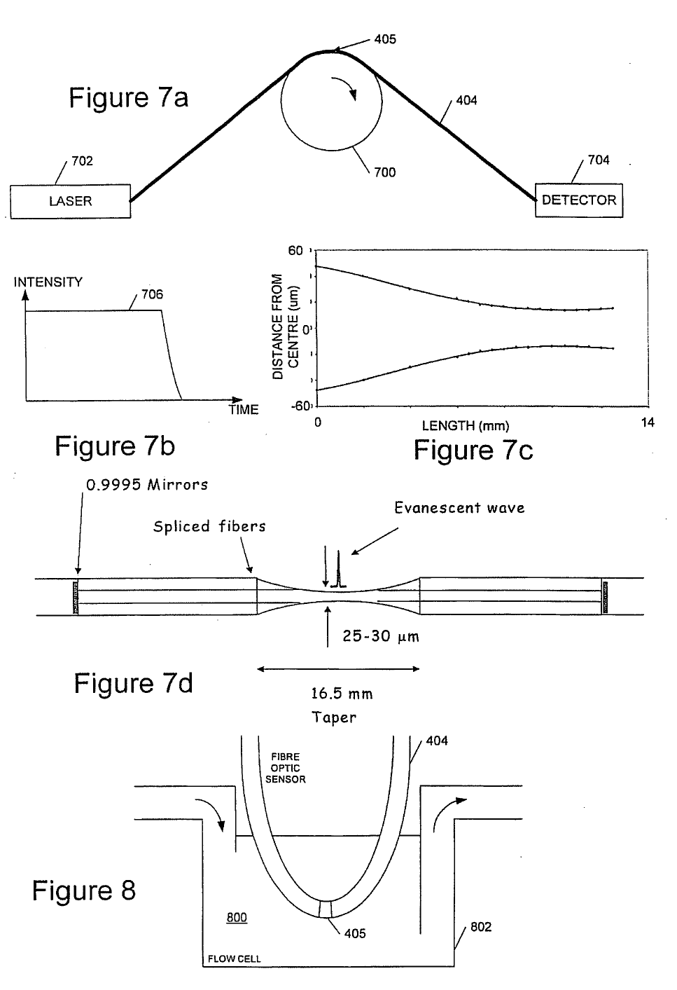

FIGS. 7a to 7d show, respectively, a procedure for forming the sensor portion of FIG. 6, a detected light intensity-time graph associated with the procedure of FIG. 7a, a taper profile, and a tapered FO sensing device;

FIG. 8 shows an example of an application of an e-CRDS-based fibre optic sensor;

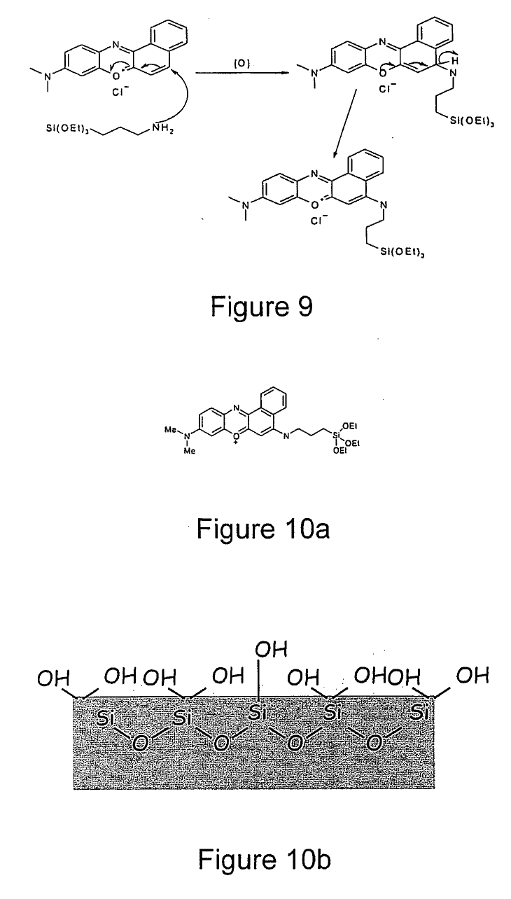

FIG. 9 shows synthesis of a Nile Blue derivative;

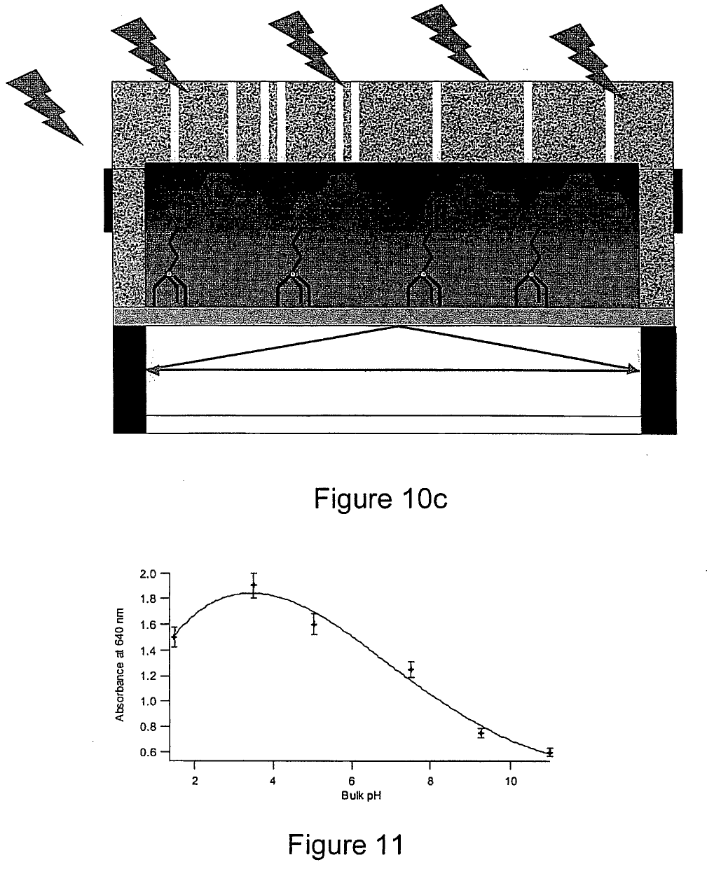

FIGS. 10a to 10c show, respectively, a silyl functionalised Nile Blue derivative, a silica/water interface, and a schematic diagram of a chromophore attached to a sensor surface to provide a pH sensor;

FIG. 11 shows variation of absorbance with pH for the Nile Blue derivative in solution;

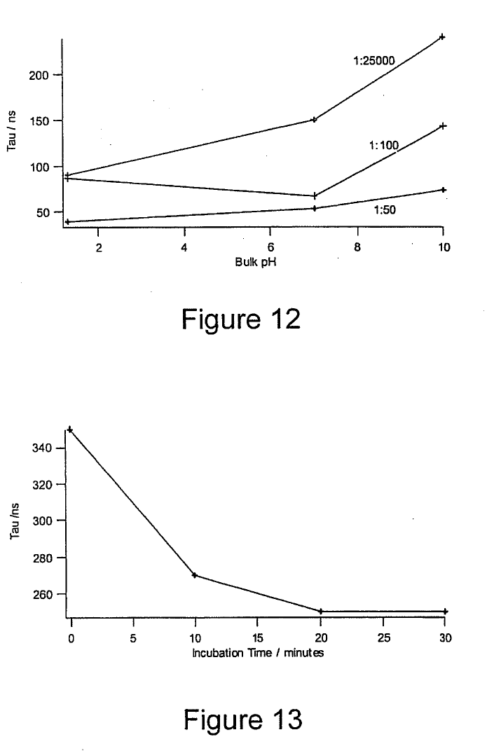

FIG. 12 shows the effect of concentration of Nile Blue in methanol on τ after treatment with different pH buffers;

FIG. 13 shows the variation of τ with incubation time for the Nile Blue derivative in methanol;

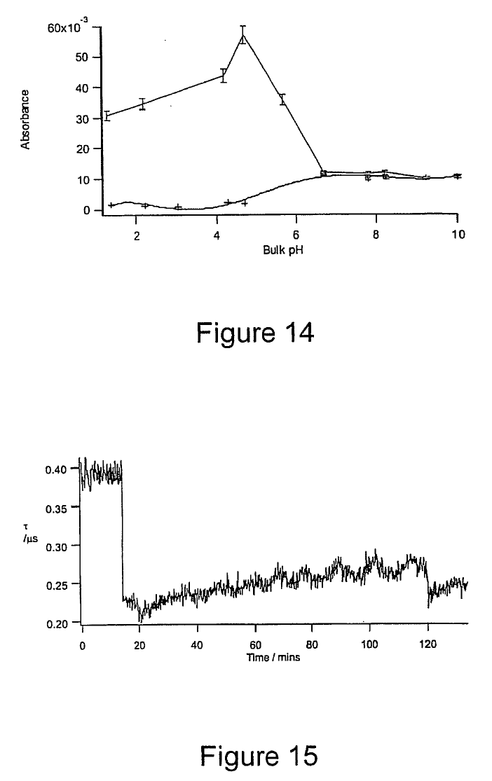

FIG. 14 shows titration of the tethered Nile Blue derivative; and

FIG. 15 shows variation of τ with time for the tethered Nile Blue derivative.

### Cavity Ring-Down Sensing Apparatus

We will first describe details of some particular preferred examples of e-CRDS-based sensing apparatus and will then, with particular reference to FIG. 9 onwards, describe techniques and improvements embodying aspects of the present invention.

Referring now to FIG. 1c, this shows an example of an e-CRDS-based system 100, in which light is injected into the cavity using a continuous wave (CW) laser 102. In the apparatus 100 of FIG. 1c the ring-down cavity comprises high reflectivity mirrors 108, 110 and includes a total internal reflection device 112. Mirrors 108 and 110 may be purchased from Layertec, Ernst-Abbe-Weg 1, D-99441, Mellingen, Germany. In practice the tunability of the system may be determined by the wavelength range over which the mirrors provide an adequately high reflectivity. Light is provided to the cavity by laser 102 through the rear of mirror 108 via an acousto-optic (AO) modulator 104 to control the injection of light. In one embodiment the output of laser 102 is coupled into an optical fibre and then focused onto a AO modulator 104 with 100 micron spot, the output from AOM 104 then can be collected by a further fibre optic before being introduced into the cavity resonator. This arrangement facilitates chop times of the order of 50 ns, such fast chop times being desirable because of the relatively low finesse of the cavity resonator.

Laser 102 may comprise, for example, a CW ring dye laser operating at a wavelength of approximately 630 nm or some other CW light source, such as a light emitting diode may be employed. For reasons which will be explained further below, the bandwidth of laser (or other light source) 102 should be greater than one free spectral range of the cavity formed by mirrors 108,110 and in one dye laser-based embodiment laser 102 has a bandwidth of approximately 5 GHz. A suitable dye laser is the Coherent 899-01 ring-dye laser, available from Coherent Inc, California, USA. Use of a laser with a large bandwidth excites a plurality of modes of oscillation of the ring-down cavity and thus enables the cavity be “free running”, that is the laser cavity and the ring-down cavity need not rely on positional feedback to control cavity length to lock modes of the two cavities together. The sensitivity of the apparatus scales with the square root of the chopping rate and employing a continuous wave laser with a bandwidth sufficient to overlap multiple cavity modes facilitates a rapid chop rate, potentially at greater than 100 KHz or even greater than 1 MHz.

A radio frequency source 120 drives AO modulator 104 to allow the CW optical drive to cavity 108, 110 to be abruptly switched off (in effect the AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IEEE bus 122. The RF source 120 also provides a timing pulse output 124 to the control computer to indicate when light from laser 102 is cut off from the cavity 108-110. It will be recognized that the timing edge of the timing pulse should have a rise or fall time comparable with or preferably faster than optical injection shut-off time.

Use of a tunable light source such as a dye laser has advantages for some applications but in other applications a less tunable CW light source, such as a solid state diode laser may be employed, again in embodiments operating at approximately 630 nm. It has been found that a diode laser may be switched off in around 10 ns by controlling the electrical supply to the laser, thus providing a simpler and cheaper alternative to a dye laser for many applications. In such an embodiment RF source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo-multiplier tube (PMT) in combination with a suitable driver, optionally followed by a fast amplifier. Suitable devices are the H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; in one embodiment an A to D on board a LeCroy waverunner LT 262 350 MHz digital oscilloscope was employed. Control computer 118 may comprise a conventional general purpose computer such as a personal computer with an IEEE bus for communication with the scope or A/D 116 may comprise a card within this computer. Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as described below. The code may comprise configuration code for LabView (Trade Mark), from National Instruments Corp, USA, or code written in a programming language such as C.

Examples of total internal reflection devices which may be employed for device 112 of FIG. 1c are shown in FIGS. 1d, 1e and 1f. FIG. 1d shows a fibre optic cable-based sensing device, as described in more detail later. FIG. 1e shows a first, Pellin Broca type prism, and FIG. 1f shows a second prism geometry. Prisms of a range of geometries, including Dove prisms, may be employed in the apparatus of FIG. 1c, particularly where an anti-reflection coating has been applied to the prism. The prisms of FIGS. 1e and 1f may be formed from a range of materials including, but not limited to glass, quartz, mica, calcium fluoride, fused silica, and borosilicate glass such as BK7.

Referring now to FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1 G samples per second (1 sample/ns at either 8 or 16 bit resolution) preferably over a period of at least five decay lifetimes, for example, over a period of approximately 5 μs. Computer 118 then controls RF generator to re-open the shutter and the procedure loops back to step S200 to repeat the measurement, thereby capturing a set of cavity ring-down decay curves in memory.

When a continuous wave laser source is used to excite the cavity decay curves may be captured at a relatively high repetition rate. For example, in one embodiment decay curves were captured at a rate of approximately 20 kHz per curve, and in theory it should be possible to capture curves virtually back-to-back making measurements substantially continuously (with a small allowance for cavity ring-up time). Thus, for example, when capturing data over a period of approximately 5 μs it should be possible to repeat measurements at a rate of approximately 20 kHz. The data from the captured decay curves are then averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e=2.718). Any conventional curve fitting method may be employed; one straight-forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

Following this initial decay time measurement computer 118 controls the apparatus to apply a sample (gas, liquid or solid) to the total internal reflection device 112 within the ring-down cavity; alternatively the sample may be applied manually. The procedure then, at step S212, effectively repeats steps S200-S208 for the cavity including the sample, capturing and averaging data for a plurality of ring-down curves and using this averaged data to determine a sample cavity ring-down decay time τ₁. Then, at step S214, the procedure determines an absolute absorption value for the sample using the difference in decay times (τ₀−τ₁) and, at step S216, the concentration of the sensed substance or species can be determined. This is described further below.

In an evanescent wave ring-down system such as that shown in FIG. 1c the total (absolute) absorbance can be determined from Δτ=τ₁−τ₀ using equation 2 below.

$$Abs = \frac{Δ t}{{ττ}_{0}} ( \frac{{t}_{r}}{2} ) \qquad ( Equation 2 )$$

In equation 2 tᵣ is the round trip time for the cavity, which can be determined from the speed of light and from the optical path length including the total internal reflection device. The molecular concentration can then be determined using equation 3;

Absorbance=εCL (Equation 3)

where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 3 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Referring next to FIG. 3a this shows a graph of frequencies (or equivalently, wavenumber) on the horizontal axis against transmission into a high Q cavity such as cavity 108, 110 of FIG. 1c, on the vertical axis. It can be seen that, broadly speaking, light can only be coupled into the cavity at discrete, equally-spaced frequencies corresponding to allowed longitudinal standing waves within the cavity known as longitudinal cavity modes. The interval between these modes is known as the free spectral range (FSR) of the cavity and is defined as equation 4 below.

FSR=(l/2c′) (Equation 4)

Where l is the length of the cavity and c′ is the effective speed of light within the cavity, that is the speed of light taking into account the effects of a non-unity refractive index for materials within the cavity. For a one-meter cavity, for example, the free spectral range is approximately 150 MHz. Lines 300 in FIG. 3a illustrate successive longitudinal cavity modes. FIG. 3a also shows (not to scale) a set of additional, transverse cavity modes 302a, b associated with each longitudinal mode, although these decay rapidly away from the longitudinal modes. The transverse modes are much more closely spaced than the longitudinal modes since they are determined by the much shorter transverse cavity dimensions. To couple continuous wave radiation into the cavity described by FIG. 3a the light source with sufficient bandwidth to overlap at least too longitudinal cavity modes may be employed. This is shown in FIG. 3b.

FIG. 3b shows FIG. 3a with an intensity (Watts per m²) or equivalently power spectrum 304a, b for a continuous wave laser superimposed. It can be seen that provided the full width at half maximum 306 of the laser output spans at least one FSR laser radiation should continuously fill the cavity, even if the peak of the laser output moves, as shown by spectra 304a and b. In practice the laser output may not have the regular shape illustrated in FIG. 3b and FIG. 3c illustrates, diagrammatically an example of the spectral output 308 of a dye laser which, broadly speaking, comprises a super imposition of a plurality of broad resonances at the cavity modes of the laser.

Referring again to FIG. 3b it can be seen that as the peak of the laser output moves, although two modes are always excited these are not necessarily the same two modes. It is desirable to continuously excite a cavity mode, taking into account shifts in mode position caused by vibration and/or temperature changes and it is therefore preferable that the laser output overlaps more than two modes, for example, five modes (as shown in FIG. 3c) or ten modes. In this way even if mode or laser frequency changes one mode at least is likely to be continuously excited. To cope with large temperature variations a large bandwidth may be needed and for certain designs of instruments, for example, fibre optic-based instruments it is similarly desirable to use a CW laser with a bandwidth of five, ten or more FSRs. For example a CW ring dye laser with a bandwidth of 5 GHz has advantageously employed with a cavity length of approximately one meter and hence an FSR of approximately 150 MHz.

For clarity transverse modes have not been shown in FIG. 3b or FIG. 3c but it will be appreciated light may be coupled into modes with a transverse component as well as a purely longitudinal modes, although to ensure continuous excitation of a cavity it is desirable to overlap at least two different longitudinal modes of the cavity

In order to excite a cavity mode sufficient power must be coupled into the cavity to overcome losses in the cavity so that the mode, in effect rings up. Preferably, however, at least half the maximum laser intensity at its peak frequency is delivered into at least two modes since this facilitates fast repetition of decay curve measurement and also increases sensitivity since decay curves will begin from a higher initial detected intensity. It will be appreciated that when the bandwidth of the CW laser overlaps with longitudinal modes of the ring-down cavity as described above, the power within the cavity depends on the incident power of the exciting laser, which enables the power within the cavity to be controlled, thus facilitating power dependent measurements and sensing.

FIG. 4a shows a fibre optic-based e-CRDS type sensing system 400 similar to that shown in FIG. 1c, in which like elements are indicated by like reference numerals. In FIG. 4a, however, mirrors 108, 110, and total internal reflection device 112 are replaced by fibre optic cable 404, the ends of which have been treated to render them reflective to form a fibre optic cavity. In addition collimating optics 402 are employed to couple light into fibre optic cable 404 and collimating optics 406 are employed to couple light from fibre optic cable 404 into detector 414.

FIG. 4b shows further details of fibre optic cable 404, which, in a conventional manner comprises a central core 406 surrounded by cladding 408 of lower refractive index than the core. Each end of the fibre optic cable 404 is, in the illustrated embodiment polished flat and provided with a multi layer Bragg stack 410 to render it highly reflective at the wavelength of interest. As the skilled person will be aware, a Bragg stack is a stack of quarter wavelength thick layers of materials of alternating refractive indices. To deposit the Bragg stacks the ends of the fibre optic cable are first prepared by etching away the surface and then polishing the etched surface flat to within, for example, a tenth of a wavelength (this polishing criteria is a commonly adopted standard for high-precision optical surfaces). Bragg stacks may then be deposited by ion sputtering of metal oxides; such a service is offered by a range of companies including the above-mentioned Layertec, Gmbh. Fibre optic cable 404 includes a sensor portion 405, as described further below.

Preferably optical fibre 404 is a single mode step index fibre, advantageously a single mode polarization preserving fibre to facilitate polarization-dependent measurements and to facilitate enhancement of the evanescent wave field. Such enhancement can be understood with reference to FIG. 4c which shows total internal reflection of light 412 at a surface 414. It can be seen from inspection of FIG. 4c that p-polarized light (within the plane containing light 412 and the normal to surface 414) generates an evanescent wave which penetrates further from surface 414 than does s-polarized light (perpendicular to the plane containing light 412 and the normal to surface 414).

The fibre optic cable is preferably selected for operation at a wavelength or wavelengths of laser 102. Thus, for example, where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm. Preferably low loss fibre is employed. In one embodiment single mode fibre (F601A from INO) with a core diameter of 5.6 μm (a cut-off at 540 nm, numerical aperture of 0.11, and outside diameter of 125 μm)and a loss of 7 dB/km was employed at 633 nm, giving a decay time of approximately 1.5 μs with a one meter cavity and an end reflectivity of R=0.999. In general the decay time is given by equation 5 below where the symbols have their previous meanings, f is the loss in the fibre (units of m⁻¹ i.e. percentage loss per metre) and l is the length of the fibre in metres.

Δτ=tᵣ/{2(1−R)+fl} (Equation 5)

FIG. 4d illustrates a simple example of an alternative configuration of the apparatus of FIG. 4a, in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC-type connector.

FIGS. 4e and 4f show examples of cavity ring-down decay curves obtained with apparatus similar to that shown in FIG. 4a with a cavity of length approximately one meter and the above mentioned single mode fibre. FIG. 4e shows two sampling oscilloscope traces captured at 500 mega samples per second with a horizontal (time) grid division of 0.2 μs and a vertical grid division of 50 μV. Curve 450 represents a single measurement and curve 452 and average of nine decay curve measurements (in FIG. 4e the curve has been displaced vertically for clarity) the decay time for the averaged decay curve 452 was determined to be approximately 1.7 μs. The slight departure from an exponential shape (a slight kink in the curve) during the initial approximately 100 ns is a consequence of coupling of radiation into the cladding of the fibre, which is rapidly attenuated by the fibre properties and losses to the surroundings.

Referring now to FIG. 5a this shows a variant of the apparatus of FIG. 4a, again in which like elements are indicated by like reference numerals. In FIG. 5a a single-ended connection is made to fibre cavity 404 although, as before, both ends of fibre 404 are provided with highly reflecting surfaces. Thus in FIG. 5a a conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow laser light to be launched into fibre cavity 404 and light escaping from fibre cavity 404 to be detected from a single end of the cavity. This facilitates use of a fibre cavity-based sensor (such as is described in more detail below) in many applications, in particular applications where access both ends of the fibre is difficult or undesirable. Such applications include intravenous sensing within a human or animal body and sensing within an oil well bore hole.

FIG. 5b shows a variant in which fibre cavity 404 is coupled to Y-connector 502 via an intermediate length of fibre optic cable 506 (which again may be coupled to cable 504 via a FC/PC connector). FIG. 5b also illustrates the use of an optional optical fibre amplifier 508 such as an erbium-doped fibre amplifier. In the illustrated example fibre amplifier 508 is acting as a relay amplifier to boost the output of collimating optics 402 after a long run through a fibre optic cable loop 510. (For clarity in FIG. 5b the pump laser for fibre amplifier 508 is not shown). The skilled person will appreciate that many other configurations are possible. For example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimeters from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

To utilize the fibre optic cavity 404 as a sensor of an e-CRDS based instrument access to an evanescent wave guided within the fibre is needed. FIGS. 6a and 6b show one way in which such access may be provided. Broadly speaking a portion of cladding is removed from a short length of the fibre to expose the core or more particularly to allow access to the evanescent wave of light guided in the core by, for example, a substance to be sensed.

FIG. 6a shows a longitudinal cross section through a sensor portion 405 of the fibre optic cable 404 and FIG. 6b shows a view from above of a part of the length of fibre optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen from FIG. 6 at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

For a Dove prism the characteristic penetration depth, dₚ, of an evanescent wave, at which the wave amplitude falls to 1/e of its value at the interface is determined by:

$${d}_{p} = \frac{λ}{2 {π ( {( sin ( ϑ ) )}^{2} - {n}_{12}^{2} )}^{\frac{1}{2}}}$$

where λ is the wavelength of the, θ is the angle of incidence at the interface with respect to the normal and n₁₂ is the ratio of the refractive index of the material (at λ) to the medium above the interface. A similar expression applies for a fibre optic. Generally dₚ is less than 500 nm; for a typical configuration dₚ is less than 200 nm, often less than 100 nm.

A sensor portion 405 on a fibre optic cable may be created either by mechanical removal of the casing 409 and portion of the cladding 408 or by chemical etching. FIGS. 7a and 7b demonstrate a mechanical removal process in which the fibre optic cable is passed over a rotating grinding wheel (with a relatively fine grain) which, over a period of some minutes, mechanically removes the casing 409 and cladding 408. The point at which the core 406 is optically exposed may be monitored using a laser 702 injecting light into the cable which is guided to a detector 704 where the received intensity is monitored. Refractive index matching fluid (not shown in FIG. 7a) is provided at the contact point between grinding wheel 700 and table 404, this fluid having a higher refractive index than the core 406 so that when the core is exposed light is coupled out of the core and the detected intensity falls to zero.

FIG. 7b shows a graph of light intensity received by detector 704 against time, showing a rapid fall in received intensity at point 706 as the core begins to be optically exposed so that energy from the evanescent wave can couple into the index matching fluid and hence out of the table. With a chemical etching process a similar procedure may be employed to check when the evanescent wave is accessible, that is when the core is being exposed, by removing the fibre from the chemical etch ant at intervals and checking light propagation through the fibre when index matching fluid is applied at the sensor portion of the fibre. An example of a suitable enchant is hydrofluoric acid (HF).

Tapered fibre cavities may also be made by pulling under heating to a known radius to produce the taper. Tapered fibres prepared in this way are available from Sifam Fibre Optics, Torquay, Devon, UK. Also the telecoms industry has developed a technology for fusing fibre optics together, coupling two or more input fibres into one output fibre by tapering the fibres and fusing the cores of the incoming fibres to the output fibre. In tapering a single fibre optic some of the evanescent field is revealed from the core and samples the region outside the taper. FIG. 7c shows an example taper profile with a minimum diameter of 27 μm and a length of 27 mm (here taking the taper length as the distance between points at which the fibre has twice its minimum diameter). The taper then be spliced into a fibre cavity to form a complete sensor, as shown in FIG. 7d. In embodiments the tapered region may be supported in a ‘U’ shaped gutter. In an alternative fabrication technique mirrors are deposited onto a fibre that is appropriate for tapering; losses of the taper may then be monitored by CRDS during the taper preparation.

Tapers have been drawn in fibre with a “W” index profile but it is preferable, for reduced loss, to use fibre with a step index profile. Fibre may be obtained from Oz Optics (Ontario, Canada), An example specification (for Lot ID: CD01875XA2) is Cladding Diameter 124.72/125.51 μm, Coating Diameter 248.77/248.9 μm, Attenuation at 630 nm 7.09 dB km⁻¹, Cutoff 612.4/619.5 nm, Mean Fibre Diameter at 630 nm 4.28/4.62 μm. The losses at 633 nm are dominated by the absorption losses of the silica in the fibre and a shift to longer wavelength can allow the operation of the cavity in a region of lower losses in the absorption spectrum of the silica. The minimum absorption occurs at 1.5 μm, the telecom wavelength.

In on example a tapered fibre was then spliced into a cavity to provide an overall cavity length of 4.2 m; more than one taper could be spliced into a cavity in a similar way. The cavity length was chosen to be this length to increase the ring down time τ (which has a linear dependence on tᵣ the round trip time). To reduce the splicing losses the mirrors may be deposited onto a fibre with a desired index profile.

In another example the fibres were fabricated in two batches, one supplied and prepared with high-reflectivity mirror coatings by INO (Institute National d'Optique—National Optics Institute, Quebec, Canada), and one supplied by Oz optics with high-reflectivity mirror coatings provided by Research Electro Optics (REO), Inc, of Colorado, USA. Each fibre was polished flat as part of a standard INO preparation procedure and then connectorised with a standard FC/PC patchchord connector. For the REO batch the mirror coatings were applied to the end of the polished fibre with the FC/PC connectors in place. The fabrication process may coat the mirrors before or after connectorisation. The batch from INO was supplied as patch-chords with a rugged plastic covering around the fibres (likely added after the mirrors were coated); the batch sent to REO had no outer coating, except the silicone covering, around 1 mm in diameter to minimise out-gassing during the coating processes. Two mirror reflectivity custom coating runs were performed, by Oz Optics and by REO. Oz specified a coating reflectivity of better than 0.9995; REO specified 0.9999 or better reflectivities (manufacturer's estimates) by their standard processes.

FIG. 8 shows a simple example of an application of the apparatus of FIG. 4a. Fibre optic cable 404 and sensor 405 are immersed in a flow cell 802 through which is passed an aqueous solution containing a chromophore whose absorbance is responsive to a property to be measured such as pH. Using the apparatus of FIG. 4a at a wavelength corresponding to an absorption band of the chromophore very small changes, in this example pH, may be measured.

The above described instruments may be used for gas, liquid and solid phase measurements although they are particularly suitable for liquid and solid phase materials. Instruments of the type described, particularly those of the type shown in FIG. 1c may operate at any of a wide range of wavelengths or at multiple wavelengths. For example optical high reflectivity are mirrors available over the range 200 nm-20 μm and suitable light sources include Ti:sapphire lasers for the region 600 nm-1000 nm and, at the extremes of the frequency range, synchrotron sources. Instruments of the type shown in FIG. 4a may also operate at any of a wide range of wavelengths provided that suitable fibre optic cable is available.

### Surface Functionalisation

We will now describe some general techniques for functionalising a sensor surface of the above apparatus, with specific reference later to a pH sensor.

Useful properties for a sensor system include specificity to a target, sensitivity to detect the target and stability, for example to facilitate real-time monitoring. Enzymes in the body, for example, are able to tell the difference between glucose and sucrose and this selectivity can be harnessed as the primary recognition event in chemical sensing, for example for monitoring blood and urine sugar levels, by attaching an enzyme to a sensing surface. The specificity of the DNA and RNA base pair interactions make the detection of a specific sequence possible. An example is mRNA found in eukaryotes and is terminated with the base sequence -AAAAA on the tail. Mounting a -TTTTT sequence gives the right binding for the A-T base pair and would attach the mRNA to the sensor surface. This may then be varied to produce a DNA or RNA specific sequence detector that might be used, for example, in the detection of DNA labels used in anticounterfeiting work.

Biological recognition processes can be based around the specific interactions of immunoglobins or antibodies, with target proteins or antigens. These interactions can either have broad specificity and respond to many similar molecules (polyclonal) or can be highly specific responding, for example, to one type of virus or bacterium from a mixture of similar strains (monoclonal). As previously mentioned this immunochemistry may be applied to the surface of a sensor. Hundreds of antibodies are commercially available raised specifically to antigens, as diverse as heavy metals, anthrax, salmonella, insulin and E. coli for example, and can be used to make a large number of different biosensors.

The “biophotonic” or “chemo-photonic” (evanescent wave) interface (here we use the terms interchangeably) can additionally or alternatively act as an affinity sensor attracting target molecules to detection sites on the surface of the sensor—for example with a silica interface a positively charged molecule can be attracted to the negatively charged surface. The silica surface is intrinsically negatively charged when placed in water and can be changed to suite the character of the target molecule. For example the surface can be neutralised with passivating agents such as trimethoxymethylsilanes (TMMS) to make the sensor surface hydrophobic and inhibit affinity binding of negative ions. Alternatively bonding a TMMS, functionalised with a positive group, to the surface makes the resulting surface positively charged and can attract negatively charged molecules.

The sensor can respond to direct absorption of light by a target, for example to probe the interface structure, or a chromophore can be tethered to or deposited on an evanescent wave sensing surface.

Implementation of evanescent wave cavity ring-down spectroscopy (e-CRDS) on an optical bench has been achieved by the simple configuration incorporating a Dove prism into a linear cavity (see, for example, A. M. Shaw, T. E. Hannon, F. Li and R. N. Zare J. Phys. Chem. B 107, (2003) 7070.17). The use of a broadband laser light source has enabled the free-running cavity configuration to be used and developed for the liquid phase studies as described above. Measurements on the acid/base characteristics of the silanol groups on the silica surface of the Dove Prism have shown a population of two Si—OH groups: 19% have a pKa ˜4.5 and the remainder has a pKa˜8.5. The silanol group density is 4 nm⁻². Studies of the adsorption isotherm of the charged chromophore Crystal Violet have shown features associated with the evolution of the charged bilayer structure next to the interface and the transition from a diffuse layer to a bilayer or Stern layer structure. The chromophore is attracted to the charged interface within the evanescent field. Further work has shown that the adsorption isotherm is pH dependent (the higher the pH the more surface charge). Thus by choice of base the bulk pH can be substantially maintained but the interface adsorption minimized or controlled. With the tethering chemistry this may be helpful as the bulk acid-base chemistry can be driven with a high pH while minimizing or controlling the surface charge.

The silanol groups can also act as anchoring points for chromophore molecules that may be tethered to the interface. This allows the silica surface to be functionalised with the tethered molecule acting as a host for a target guest species. When the guest species or ligand has bound to the chromophore it changes colour, the absorbance changes and this is detected with the e-CRDS technology. The broadband nature of the laser light source in the above described free-running cavity configuration is well suited to these solution phase optical properties.

Tethering a molecule to the interface is the first step in generating a smart surface or chemo-photonic surface as the basis of a detection sensor technology. For a particular application the length of the tether, the deposition rate of the chromophore onto the surface, and the surface coverage of the chromophore at the surface are preferably selected, for example by routine experiment, to be within the loss budget of the e-CRSD cavity. Details are presented here of the tethered chromophore investigations with a specific demonstration of a pH sensor.

Initial experiments synthesised a tether onto Nile Blue chromophore that absorbs at 637 nm, the wavelength of the laser. The modified molecule was then bound to the prepared silica surface and the absorbance change as a proton binds to the molecule is monitored by e-CRDS. Preferably the tether should have little effect on the chromophore's optical or binding specificity properties.

To synthesise a tether Nile Blue, (0.2 g, 0.64 mmol) and 3-aminopropyltriethoxysilane, (0.14 g, 0.64 mmol), were refluxed in methanol solution (30 cm³) for 3 hrs. The resultant solution was increased in volume to 60 cm³ by the addition of more methanol. The resultant solution was washed with hexane and chloroform until the washings became colourless. The solvent was removed in vacuo and the resultant solid dried under vacuum. A ¹H NMR spectrum was obtained and the derivative characterised fully according to standard organic synthesis practice. The synthesis yields tend to be in the range 10-20%. A higher yield can be obtained using a large excess of 3-aminopropyltriethoxysilane, and obtaining the product by precipitation following the addition of excess THF. However, the product tends to polymerise. A reaction scheme for the tether bonding reaction is shown in FIG. 9, which shows synthesis of a Nile Blue derivative.

The resulting characterised species for tethering to the silica surface is shown in FIG. 10a, which shows a silyl functionalised Nile Blue derivative. FIGS. 10b and 10c show, respectively, a silica/water interface and a schematic diagram of a chromophore attached to a sensor surface to provide a pH sensor. The tether shows a triethoxysilane group that forms a Si—O—Si bond at the surface to bind the species to the surface. The ethoxy group acts as a leaving group when the silicon undergoes nucleophilic attack by the surface silanol group. The OEt leaving group can be replaced with a chloro group producing a chlorosilane derivative with different tethering properties. The tethering process can be varied to provide 1, 2 or 3-OEt or -Cl on the tethered molecule to establish 1, 2 or 3 anchoring points to the surface or the formation of a cross-linked surface polymer chain.

The Nile Blue derivative was diluted 1:100 as provided in methanol. Prior to use, the pH of the methanol was adjusted to the appropriate value using ammonia water or 1M HCl this was monitored using the pH meter. Methanol was used as the background. 1 ml of the stock Nile Blue derivative was added to 100 ml of the adjusted methanol and the UV spectra at 637 nm was monitored in solution. FIG. 11 shows variation of absorbance with pH for the Nile Blue derivative in solution.

To clean the prism all prism surfaces were clamped into the doping apparatus and sealed using a Teflon gasket. The doping apparatus essentially comprised a boiling tube or test tube from which a section has been removed on the side. The tube is fabricated into an L-shape with the removed section on the upper surface of the horizontal arm; preferably the section has the same width and length as the prism surface and the perimeter has been flattened to allow even contact with the prism. A silicone rubber or Teflon gasket (or other suitable material for a specific solvent system) is used to make a seal with the prism, and the prism and gasket are then clamped to the side of the tube forming a water-tight or solvent-tight seal, which allows the temperature of the fluid within to be raised to the melting point of the gasket, typically 80-100° C. A magnetic stirring-flea may be included within the lower section of the horizontal arm to allow the mixture to be stirred, facilitating thorough mixing at the interface.

An airtight seal was achieved and tested using ultra pure 18 MΩ cm⁻¹ water (machine details) and the prisms were dried by heating the empty apparatus to 100° C. for 20 minutes. Piranha solution (H₂O₂:H₂SO₄ 1:3 (v/v)) was placed in the apparatus and the entire device was tilted to 25 degrees in a sand bath to ensure even contact with the solution. The piranha solution was heated under reflux conditions for 1 hour at 80° C. followed by exhaustive washing in situ with ultra pure 18 MΩ cm⁻¹ water to remove any traces of the piranha due to its explosive nature in the presence of organic solvents. The prism was again dried as previously outlined.

A series of conditions were investigated for the tethering procedure varying time from pH and concentration concentrations of Nile Blue derivative. All tethering procedures were carried out in the doping device at 65° C. or room temperature. Approximately 20 ml of this solution was placed in the doping apparatus and the prisms were refluxed for the appropriate time. Preliminary studies revealed 65° C. to be preferable. The pH-adjusted methanol Nile Blue derivative solution (adjusted to with ammonia water or 1M HCl)) was monitored using a handheld pH meter (WTW pH330 kit with a pH/temperature electrode). Following tethering the faces of the prism were dropped and dragged with methanol to ensure no residue was present on the faces and the doped prism was placed in the cavity and washed with methanol.

Following this e-CRDS experiments were performed in a Dove cavity in a free-running cavity configuration as described above. The light source was a cw diode laser centred at 639 nm with a 5 nm bandwidth. The light source was chopped at 9 kHz to allow the ring-down of the optical cavity to be observed. The cavity was formed from two high reflectivity mirrors (R>0.999, Layertech) arranged in a linear configuration.

The mirror reflectivity was optimized for 637 nm to be co-incident with the laser; the coating had a band width of several 10 s of nanometers with a slowly varying reflectivity.

A Dove prism is placed within the cavity to act as a total internal reflection element, which preserves the optical alignment of the cavity. Antireflection coatings are placed on the legs of the prism to minimise the reflection losses from the surfaces and to preserve the Q of the cavity. AR coatings were made in a custom coating run by SLS Optics on the legs of the Dove Prism. The specified anti-reflection<0.2% at 633 nm and 45° for p-polarised light. This specifies a round trip loss of 0.8% for the Dove Cavity. Typical ring-down times for an empty cavity including the Dove prism are 400 ns with a standard deviation στ/τ ˜2% or better, for example down to 0.01%.

A flow cell was designed to cover the evanescent field produced at the total internal reflection element and all solutions are flowed over the surface using a HPLC pump. A flow cell may be designed as follows: a glass flow cell is fabricated from a small 1 mm bore glass capillary tube and formed into a U-shaped vessel. Part of the outer glass wall is ground flat through to half-way through the capillary bore, exposing a length of the capillary of order 25 mm and a width of 2 mm. This region is sufficient to allow the evanescent field to be completely covered on the back surface of the Dove prism. The total volume of the flow cell may be of order 3 ml. The internal surfaces of the flow cell may be passivated with trimethoxymethyl silane (TMMS) to allow a water-repellent coating to be placed on the glass. This inhibits the absorption of charged species to the surface. The flow cell may be clamped in place over the back surface of the prism using any gasket material appropriate for the solvent system in the experiment, typically silicone rubber or Teflon. The flow through the cell may be maintained between 1-9 ml/min by a high performance Liquid Chromatography (HPLC) pump or a peristaltic pump. All e-CRDS experiments on the functionalised prism surfaces were performed with the free running Dove cavity configuration.

A swan-necked flow cell allowed liquid to flow over the prism surface with a volume of approximately 3 ml. The prism was placed in the cavity and a silicon gasket between the flow cell and the prism to expose as much of the prism surface to the liquid as possible. Liquid was flown over the surface at a rate of 2.5 ml/min using the HPLC pump with Teflon tubing. Priming the system with the liquid prior to use averted air bubbles.

The prism was aligned in the cavity in the presence of methanol to give the highest background τ possible before any buffers were added to the surface and also to remove any unbound Nile Blue derivative. The pH of the buffers (18 MΩ cm⁻¹ water) was adjusted using ammonia water or 1M HCl and monitored using the pH meter. All solutions were allowed to flow over the surface until a stable baseline was taken (approximately 100 time points). The tethering of the molecule to the prism was monitored by repeatedly flowing methanol or water followed by methanol over the surface to endure a stable base line and that any unbound material had been removed. The buffers with varying pH of interest were then introduced. Each experiment was taken 3 times.

In another example a single-pass flow cell for a Dove prism was constructed from polytetrafluoroethene (PTFE) with a flow channel matched to the prism width of 10 mm machined into the underside of the block. Once clamped and sealed to the upper prism surface with a 1 mm thick nitrile ‘O’-ring, the flow cell volume was 190 μl. Samples were allowed to flow through the cell with a maximum flow rate of 4 ml per hour from a syringe pump; this corresponded to a maximum linear flow velocity of 0.14 mm s⁻¹. The velocity of the flow through the cell determines the rate of transfer of molecules from the bulk solution to the surface. Calculation of the flow Reynolds Number indicates the type of flow regime present within the cell. This is found from:

$$Re = \frac{ρ \times u \times d}{μ}$$

where ρ is the fluid density, u is the flow velocity, d is the characteristic flow dimension and μ is the fluid viscosity. Assuming fluid viscosity and density to be equal to that of water at 25° C. (i.e 0.8909×10⁻³ N s m⁻² and 998 kg m⁻³ respectively) with a cell dimension of 1 mm, the Reynolds Number is 0.16. With highly viscous, laminar flow in ducts existing up to Reynolds Numbers exceeding 1, this value indicates that the flow regime within the cell was truly laminar and thus diffusion limiting conditions prevailed. At such slow flows, the laminar boundary layer is estimated to be fully developed within 1 μm of the cell entrance

As previously outlined the conditions under which the Nile Blue derivative was deposited on (tethered to) the surface was altered in order to give the maximum response of the surface to changes in pH. The effect of concentration of Nile Blue derivative concentration and incubation times are shown in FIG. 11. The pH of the Nile Blue derivative in methanol was kept constant at pH 10 to obtain maximum doping of the silica surface due to the opening the Q₃ sites; all studies shown were also carried out at 65° C. All the results shown are for the surfaces after methanol was carried out (ensuring a stable baseline) to ensure that the unbound derivative was not taken into account. All schedules were carried out 3 times to ensure consistency of the results.

FIG. 12 shows the effect of concentration of Nile Blue in methanol at pH 10 incubated for 30 minutes at 65° C. on τ after treatment with different pH buffers. At higher concentrations 1:50 dilution of the Nile Blue derivative there is a larger change in τ perhaps due to more of the derivative binding to the surface in this time. When the pH is changed there is little deviation in τ; if a lot of the Nile Blue derivative has adsorbed to the surface the absorbance may in fact still be too high and therefore it will be unable to detect such changes. At lower concentrations 1:100 the absorbance is not as great and there appears to be a change in absorbance with change in pH of the buffer solution. At very low concentrations this change is pH is more evident perhaps due to less derivative on the surface but this gives a more responsive surface.

FIG. 13 shows the variation of τ with incubation time for the Nile Blue derivative in methanol at pH 10, 65° C., 1:25000 dilution of T₀. Having established effects of concentration the effect of time was investigated and it was noted that as the incubation time was increased there was a decrease in the original T₀ but that after 30 minutes this did not change. This incubation time was sufficient to show pH changes without saturating the signal and therefor these conditions were used for further experiments.

As previously alluded to, a silica surface contains two types of silanol group: SiOH known as Q2 and Q3 both with different pKa values. The Q2 site has two Si—OH groups pointing away from the surface with two Si—O groups into the bulk: (O₂—Si)—(OH)₂ whereas the Q3 site has the structure (O₃Si)—OH (see, for example, FIG. 10b). Co-operative binding of a charged species to the Q3 group can be written as follows:

(O₃Si)—O⁻+nI⁺→(O₃Si)—O⁻Iₙ⁺

where n is the stoichiometric binding coefficient, which need not be an integer, and I⁺ is a counter ion. The absorbance of the components within the charge-layered interface can be described as the convolution of the concentration profile with the electric field of the evanescent wave:

$$Abs = ɛ {\int }_{0}^{∞} c ( z ) exp ( - z / {d}_{p} ) dz$$

where c(z) is the concentration profile normal to the surface, z is the normal, dₚ is the penetration depth of the evanescent field and ε is the extinction coefficient, for example for CV⁺, at the bulk pH. The extinction coefficient may be assumed to have the same value as determined in solution from the UV/Vis spectrum. The absorbance is then formally the Laplace Transform of the concentration profile.

The pH-dependent adsorption isotherms for the charged chromophore crystal violet, CV⁺ (in solution), have been measured with three different bases by a free-running cavity implementation of evanescent wave cavity ring-down spectroscopy. The three bases (ammonium hydroxide NH₄OH, potassium hydroxide KOH, and NaOH) had similar ionic radii (cf steric effects) to show competitive binding between CV⁺ and Na⁺, K⁺ and NH₄⁺ and partial surface neutralisation by the ammonium ion due to proton transfer reactions. The ratio of the maximal absorbance measurements at pH 5.10 and 9.05 was consistent with a Q2:Q3 silanol site ratio of 72.8:27.2. The adsorption isotherms were interpreted in terms a co-operative binding adsorption allowing more than one ionic species to bind to each silanol group. The surface concentration is consistent with a silanol charge density of 1.92±0.55 nm⁻² and a total neutralised interface layer structure extending (in this example) 9 nm from the surface. Direct binding to the silica surface appears to form a layer that substantially completely neutralises the surface, restricting the charged interface to only a few nanometres (less than 50 nm, 20 nm or 10 nm) for charged species. The ionic strength of the solution within the layer is however much higher than in the bulk and surface concentrations of order 17 M have been found. This can be generalized to provide a general method of increasing sensitivity by increasing the local/surface concentration of a substance, property or parameter to be sensed, by controlling pH and/or acid/base type/strength.

The pH dependent adsorption of molecules to a surface shows identifies a useful surface functionalisation technique. Often the acid-base characteristics of the bulk solution need to be controlled to induce hydrolysis reactions or equivalent requiring the pH to be maintained at high values such as pH 10. However pH 10 generated by adding NaOH (inorganic bases in general) results in a complete deprotonation of the SiOH groups on the surface making both Q2 and Q3 sites chemically labile for functionalisation. Switching to a base with an exchangeable proton such as NH₄⁺OH or any of the organic amines, established an equilibrium between the pKa of the silanol sites and the NH₄⁺ ion. The result is a partial neutralisation of the surface by proton exchange between the SiO- and NH₄⁺ species. Hence the bulk pH can be preserved at high pH but the surface charge can be moderated to allow control over the degree of coverage of the surface.

Tethering molecules to, say, substantially the Q3 sites on the SiO₂ surface would provide a surface coverage of 27% leaving the remaining Q2 sites as SiOH groups with the native acid-base characteristics (deposition at low pH favours binding to the Q3 silanol sites and so restricts the degree of coverage ie selecting a low pH should only allow about 27%—say less than 40%—of the surface to be covered). However the Q2 sites (or residual sites in general) provide a further site for the co-functionalisation of the surface. Q2 tethering on long-chain hydrocarbon materials produces a layer that is hydrophobic and would favour non-polar molecule to bind to the sensor surface adjacent to the chromophore target molecule. An example would be an estrogen sensor whereby the estrogen is attracted to the non-polar surface in which it partitions favourably, increasing the local concentration around the sensing molecule. The converse is true where the Q2 can be functionalised with hydrophilic molecule attracting charged species or to the sensor interface close to the sensing molecule. The intrinsically low surface coverage required for e-CRDS detection makes this possible.

### pH and Other Sensing

We next describe pH sensing. The variation of absorbance of the tethered species as a function of bulk pH is shown in FIG. 14, which shows titration of the tethered Nile Blue derivative. The increase in pH is seen in the upper trace, showing a dramatic decrease in absorbance from pH 5-pH 6.5. However when the pH is reduced from 10 to 1 there is a different response from the interface, associated with the intrinsic interface capacitance.

Binding of the tethered derivate to the silica surface has not formed a complete monolayer (calculations suggest as little as 10⁻⁵ of a monolayer) as the free silanol groups are still allowing the surface to become charged. This enables the charged properties of the interface to be controlled with sufficient molecules tethered to the surface to observe the absorbance change. The surface can thus act as an affinity surface as well as the chromo-photonic surface. The intrinsic charging characteristics can be seen in FIG. 25 which shows variation of τ with time for the tethered Nile Blue derivative where the variation of τ with time is observed over an extended period.

The variations observed in FIG. 15 appear random and are associated with the very small pH changes at the interface changes its structure. From the absorbance change associated with the one pH unit suggests that a pH sensitivity of order 0.001 pH units should be possible. The variations observed in FIG. 15 are the first such to be observed at an interface with such extreme sensitivity.

In general we are not forming a complete monolayer coverage as determined by the overall absorbance change. Assuming that the extinction coefficient for the molecule tethered at the surface is the same as that in solution is reasonable for low surface coverages but as the coverage increases the close proximity of the other tethered molecule may shift this. The un-occupied sites at the surface are available to respond to the bulk pH as on the native surface so at pH 4.5 or so the native Q₃ sites will become charged and at pH 8.5 the remaining Q₂ sites will become charged.

The charging at the interface induces the following effects: an increase in the concentration of positively charged species at the surface that depends on the surface potential but for a full charged native surface the maximum potential is −120 mV giving an interface concentration some 2 orders of magnitude greater than the bulk concentration. This determines the surface pH (H⁺ concentration) and thus can change the response of the sensor. The negative ion concentration is similarly depleted by up to 2 orders of magnitude but negative species will be present in the interface as co-ions. The increased concentration effect at the surface may cause a change in the absorbance of the species tethered to the surface—a solvato-chromic effect—but this will tend to be constant for a fixed surface doping of tethered molecules. The un-occupied sites may be functionalised after the tethered ligand has been deposited to tune the electrostatic properties of the surface for a specific task. For example, if we were attracting an anion from the bulk we would make the surface positively charged (the converse likewise holds). We may further tune the polarity or hydrophobicity/hydrophilicity of the surface to attract fatty or polar molecules to the tethered ligand. The charged surface can cause hysteresis as seen in FIG. 14 due to the difference in energy required to remove a charged species from a charged interface: the more charged the interface the more electrical work has to be done to remove the proton, and hence this can be used as a measure of the interface capacitance. It is believed charged layers form in response to the surface charge from the simplest Gouy-Chapman model of an exponentially decreasing electric field away from the surface to a complete charged layer acting as a capacitance layer. The interface capacitance for the fully charged silica surface has been estimated as 500 μF cm⁻² depending on the precise site density.

The tethering of a novel Nile blue derivative to the silica surface of a Dove prism has been achieved revealing small changes in interface structure not previously observed. There are a number of fundamental areas of physical chemistry that are opened by these observations. These include the first direct capacitance measurement of an isolated interface, and also the first optical measurement of interface capacitance.

The extinction coefficient of Nile Blue and the derivative will generally vary in the surface layers structure as a function of surface coverage. The optical properties of the chromophore will also vary as the interface characteristics change. The interface charge and capacitance determines the electrochemical gradient of charged species at the interface and this in turn affects the absorption processes. The dynamic range of the sensor can be limited by the saturation of the ring-down technique and as such can be a function of surface coverage. Passivating the un-tethered surface with a neutral species (for example TMMS for a non-polar surface or an amino derivative for a positively charged surface) can reduce the surface capacitance effect but this in turn can reduce the sensitivity of the interface to pH changes. The electrochemical gradient at the interface depends on the number of un-occupied silanol sites, which are also responsible for the surface charge.

Initial experiments were performed at a wavelength of 637 nm but this wavelength is not a restriction. The wavelength can be varied from 400 nm-2 μm in a fibre optic system (limited only by the availability of suitable fibre optics—the wavelength range can be extended in non-fibre optic systems), as long as the absorbance of the chromophore changes at the interrogation wavelength. Taper construction need not be varied with the wavelength used. The chromophore can be synthesised to act as a host for any target molecule. There are many examples of these in the literature although a simple tether may need to be added to the structure of the molecule. However other deposition techniques not requiring a tether may also be employed. For example other deposition techniques not requiring a tether are possible with a support material such as a gel or a mesoporous material which is constructed around the surface but within the evanescent field. This can physically trap the molecules which then change colour in the normal way.

Applications include a dirty bomb sensor, for example for UO₂⁺, a nitric oxide (NO) sensor using dinitroanalines, a sensor based on a crown ether, e.g. for K⁺ and Na⁺ to name but two species that may be detected by crown ethers, heavy metal sensors, for example based on Thiacrown ethers sensitive to Hg and Cd. Chemistry Review 91 (1991) 17211-2085, hereby incorporated by reference in its entirety, provides an extensive list of compounds (in excess of 500) that have been used to detect cations and anions in solution such as H⁺, Mg²⁺, Ca²⁺, Cu²⁺, Ba²⁺ to name but five.

Generally all surfaces in the presence of water will acquire a small layer of organisms that will adapt to the surface conditions. This is a problem when the waste products of metabolism affect the contents of a closed container e.g. hydraulic fluid in a cylinder. Monitoring for bio-fouling may employ the bacterium Streptomyces coelicolor, which conveniently produces a blue chromophore as a secondary metabolite. This enables e-CRDS to monitor the growth and rate of production of the bacterium on a surface. Observations on a living (or dead) biological organism may also have applications in, for example, drug screening.

The technique described herein are not restricted to solution phase detection—a surface gel can convert a gas-phase species to an interface solution. Indeed there can be sufficient water at the interface to solvate a gas phase species of interest. Surface gel example is dialysis tubing with known pore size (a few microns) and photopolymerisation of tripropylene glycol diacrylate by photo-activating at 310 nm with various photo initiators such as a morpholino ketone (BDMB Irgacure IC 369) bisacylphosphine oxide (BAPA Irgacure 819) to control the extent of polmerisation. In embodiments the molecular absorbance properties can be tuned to bring the chromophore into resonance with the exciting wavelength. Increasing the taper diameter of the fibre cavity can ameliorate the saturation of the sensor at high concentrations as reduction in the evanescent field can allow the surface colour change to be much greater before detection by e-CRDS. For intensely absorbing species it can be possible to observe the absorbance with only a single pass, two passes or just a few passes.

### Operating Wavelength(s) and Loss Budget

In some circumstances there is an advantage in moving to longer wavelengths such as 820 nm or 1.5 μm as this has the potential to reduce propagation losses within a fibre. Light sources are available at high power both at 820 nm and 1.5 μm, products of the telecommunications industry. The fibre transmission losses are generally much lower at 820 nm, ˜2 dB km⁻¹ giving ring down time for a 2 m cavity of 4.1 μs and a round trip transmission of 0.997. Thus loss is still dominated by the fibres at 820 nm and the mirror losses do not need to be better than 0.999. At 1.5 μm the fibre losses are 0.18 dB km⁻¹ and for a 2 m cavity give a cavity ring down time τ of 14.7 μs with a round trip transmission of 0.9993. Mirror reflectivity now becomes important and a cavity operating at this wavelength would preferably employ a 0.9995 or better mirror specification. At each wavelength the cavity parameters changes and the power and detection characteristics can be balanced by routine experiment. Calculation of the minimum detectable absorbance change suggests that the detection limit at 820 nm will be nearly 4 times better than at 639 nm and at 1.5 μm, some 10 times better than at 639 nm. Hence an 820 nm cavity will have a detection sensitivity of order 2×10⁻⁵. The skilled person will recognise that fibre optic e-CRDS will work within any fibre optic of tolerable transmission loss (of order 8 dB km⁻¹).

A longer wavelength than 639 nm, say ˜800 nm, may be used for example with the previously mentioned “dirty bomb” sensor surface. More generally a functionalising molecule may employ an extended porphyrin structure to tune the molecular electronics into this region of the spectrum. For example a range of expanded porphyrin molecules (e.g. isoamethyrin) bind selectively to actinyl ions, UO₂²⁺, PuO₂²⁺ and NpO₂²⁺ and initiate an abrupt colour change. These molecules absorb strongly at around 820 nm when bound to the ions and have very high extinction coefficients, and should be able to detect sub-ppb concentrations of actinides in real time. In a dirty bomb scenario, the plume of radioactivity will spread over a large area around the initial explosion and the attack profile and the progress of decontamination can be monitored. Any granite building will provide a background radiation count due to trapped radon but the background levels of actinides will be essentially zero. The sensor may be deployed remotely or in a network to monitor decontamination over a long period of time, for both airborne and waterborne contamination.

Liquid phase absorption spectra at 1.5 μm (6666 cm⁻¹) tend to be dominated by overtone absorptions but gas phase absorption occurs at these wavelengths, in particular for CH₄ and CO₂, which may be employed for monitoring submarine environments. In a simple arrangement the target molecule is required to land on the silica surface before detection, but the collision with the surface is directly proportional to the gas phase concentration. Longer wavelength radiation may also be employed with a suitable chromophore. For example, infrared chromophores tuned at 1.5 μm can be designed to allow the much lower transmission losses of silica at this wavelength to be exploited. For gas sensing gas overtone absorptions at 1.5 μm should be detectable within the evanescent field of a tapered cavity and in addition, condensed gases should also be detectable. Also specific molecules may be designed to catch target gases according to the functionalised or smart surface chemical sensor concept.

There are many other vibrations in the mid infrared which can be used, such as 1150 nm for the first overtone of the —CH₃ group in molecules and the 1400 nm —CH₂ combination band, which has been used the octane number of gasoline and which is of relevance to the petrochemical industry. The near IR and mid IR regions of the spectrum have potential for monitoring the properties of a collection of C, N, O, H species, for example for applications in industries such as the food and drink industry. Also, an e-CRDS sensitivity of order 10 ppm in absorbance offers potential for lower detection levels and tighter tolerances in the specification of aviation fuel.

Multiple wavelength (e.g. wavelength division multiplexed) sensing may be employed. For example haemoglobin may be employed as a functionalising material to detect oxygen, CO, or NO, this having an absorption at 425 nm (due to the ion) and at 830 nm (due to the porphyrin ring).

Scatter at the surface depends on the relative sizes of the surface/interface structures and the wavelength of the interrogating radiation. Surface architecture close to the wavelength of the radiation scatters light from the evanescent field efficiently and can seriously affect the cavity loss budget. Near field structure limited to the first few tens of nanometers for the Dove prism configuration represents only some 10% (say <50% or <20%) of the penetration depth of the e-field. Scatter losses from architecture close to the surface (near field) are smaller.

As described above embodiments of the sensor use optical detection of a colour change in a chromophore tethered to a functionalised silica interface. The chromophore responds to changes in the local sensor surface environment and can produce an absolute measure of pH with an accuracy of order 100 ppm. Measurements of pH at this level of sensitivity enables small transient changes in buffer systems to be monitored in real time as a diagnostic for the environment and response of the buffer to a change in chemistry.

One application is real-time observation of the bicarbonate/carbon dioxide buffer in the blood as small variations in pH are diagnostic of respiration and hypoxia within the blood stream. The bicarbonate/CO₂ buffer effectively acts as a “chemical heartbeat” for blood chemistry and, for example, a real time monitor of blood electrolytes or, for diabetics, real-time glucose/insulin monitoring.

For example, a fibre sensor may be housed within a hypodermic needle or catheter will allow the sensor to be direct to regions of interest within the body. This alongside endoscopy, providing chemical information as well may be used as visual inspection. A series of chemical sensors may be provided alongside the endoscope to investigate, for example, pH towards an atherosclerotic inflammation in the heart which shows a significant gradient varying locally by over two pH units.

Potassium is a universal electrolyte and monitoring the levels of this ion in the blood or in nerve cells may use modified crown ethers. These large ring molecule bind the K⁺ specifically (differentiating between Li⁺ and Na⁺) and a colour change can be initiated on binding.

NO is a very important transmitter within the body and is believed to be involved in aging radical chemistry, inflammation and cancer propagation but it is hard to detect in vivo as it is quickly metabolised. There are no good NO specific sensors at present but trials with methyl violegen suggest that tethering this molecule to the surface provides a sensor which will be very sensitive to low concentrations of this molecule with the advantage of being deployed locally within the body.

In embodiments of the above described apparatus the occupancy of the silica absorption sites controls the maximum response or saturation of the senor surface. The site density for unprepared silica is of order 4 nm⁻². Complete occupancy of a chromophore has a measurable absorbance given by ρ*σ where ρ is the site density and σ is the absorption cross-section for the chosen chromophore. For example for methyl violet σ is 1.6×10⁻¹⁷ cm² giving a monolayer absorbance of 6.36×10⁻³. The sensitivity of one instrument is 1 part per million so surface coverage of 0.01% is the minimum detectable coverage. This corresponds to 10¹⁰ molecules. However the cross-section for other chromophore molecules can be two orders of magnitude bigger than for methyl violet improving the detection threshold to 10⁸ molecules. For this example the dynamic range for complete coverage corresponds to 10⁴ molecules to saturate the sensor surface. The number of surface sites can be increased by improving control of the surface architecture to build branched functional groups onto the surface, which would allow other molecules to bind to the interface. The e-wave is sensitive to of order 240 nm of the silica (BK7) air interface.

Predicted sensitivity for species such as H⁺, Mg²⁺ and UO₂⁺ is of order parts per trillion or lower based on detecting an absorbance change of 10⁻⁴ and an extinction coefficient of order 10⁶ M⁻¹ cm⁻¹. For example, isoamethyrin has an extinction coefficient of 3.3×10⁵ M⁻¹ cm⁻¹ at 800 nm which drops by 50% on binding to a uranyl complex.

As previously mentioned the negative potential of the surface can be tailored for individual affinity sensors, for example based on trimethoxymethyl silanes optionally derivatised so that the chemistry of the derivative can be controlled to change the negative character to positive or neutral. The hydrophobicity/hydrophilicity nature of the surface can also be changed by binding long-chain alkyl substituents to the surface or sugar derivatised compounds. Additionally or alternatively, as described above, tethered chromophores bound to the surface can be used as the absorption site, changing colour on binding. Optionally chromophore synthesis can be initiated at the surface producing the chromophore as a result of a chemical reaction and photochemistry at the surface can then be used to produce a detectable change in the chromophore absorption spectrum. In embodiments surface imprinting and/or soft lithography may be employed so that, for example, regions of the senor surface can be masked whilst others are activated, leading to regions of targeted chemical character.

For affinity binding, binding constants determine the stability of binding of a ligand to an immobilised host molecule. The rate at which the binding occurs informs on the nature of the binding event and can be diagnostic of competitive binding ligands. Investigation of the binding constants and binding kinetics may be helpful.

We will next outline some chromophore binding colour changes. A chromophore bound to a known DNA sequence changes colour on binding of an antisense sequence and a similar analysis can be performed for RNA sequencing. Trace sequence detection can be used for counterfeit monitoring and tracing. For example placing known sequences of DNA or RNA within a shipment can provide a DNA fingerprint of the origin of the shipment, in principle detectable by the e-CRDS techniques described herein. A multiplexed array may be employed for parallel target analysis, for example using DNA/RNA-based for multiple target detection.

For metal ion detection fluorescent molecular probes have been designed for many ions such as Ca²⁺ (as previously mentioned) and molecular probes may also be employed. These fluorescent molecules may be modified for absorption probes by tuning the absorption maximum. The system may also be employed for detection of a level population arriving in a level that is not populated directly but pumped by fluorescence and intersystem crossing to a fluorescent state. Once either is populated it may be possible to monitor the population change by absorption.

For an alternative pH sensor a silica surface may be functionalised with 3-aminopropyltrimethoxysilane providing an amino functionalisation to the surface. The indicator chromophore may then be a derivative of Medola Blue that is chemically bonded to the amino derivative on the surface. The tethered molecule can then change colour on protonation with a colour change observed as a shift in the absorbance spectrum of the molecule. This is a specific example of generic tethering technology.

Turning now to interface refreshment and stability, electrical polarity changes at the interface, mediated by a charged surface of metal or conducting polymer, can be used to reverse the potential on a surface initiating a change in the binding constant of a detected ligand. Alternative photochemical cleaning based, say, on TiO₂ may be employed. Titania absorbs light around 300 nm resulting in the generation of electrons. Subsequent oxidation of species on the surface by the electrons can be used to initiate the departure of a bound ligand to a surface. A cleaning flash of radiation from one detection event to the next is thus potentially able to refresh the sensor surface. TiO₂ comes in two forms; rutile and anatase; rutile is the most photoactive in forming electrons and is therefore preferred. Additionally or alternatively the sensor surface may be protected by a 3D interface architecture, for example to reduce the risk of poisoning the surface in a field instrument. This can be achieved by building a sensor atrium into which substantially only molecules of selected physical and chemical properties are admitted. This can be achieved by applying a potential to a porous atrium ceiling allowing positive and negatively charged species in and out of the atrium. This also represents a refreshing mechanism. Furthermore 3D architectural selectivity allows separation techniques to be brought to bear on a mesoporous material designed around the sensor atrium and, in embodiments a lab-on-a-chip although the chip may be fabricated above the atrium. This facilitates deployment in a hostile environment. Reproducibility for concentration profile monitoring may be achieved by aiming to maintain a stable detector environment within the sensor atrium.

No doubt many effective variants will occur to the skilled person and it will be understood that the invention is not limited to the described embodiments but encompasses modifications apparent to those skilled in the art found within the spirit and scope of the appended claims.

1-41. (canceled)

42. An evanescent wave cavity-based optical sensor, the sensor comprising:
an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function;
a light source to inject light into said cavity; and
a detector to detect a light level within said cavity; and
wherein said TIR surface is provided with a functionalising material over at least part of said TIR surface such that said evanescent wave interacts with said material;
whereby an interaction between said functionalising material and a target to be sensed is detectable as a change in absorption of said evanescent wave.

43. A sensor as claimed in claim 42 wherein said sensor is a cavity ring-down sensor, wherein said cavity is a ring-down optical cavity for sensing a substance modifying a ring-down characteristic of the cavity; wherein said light source comprises a continuous wave light source for exciting said cavity; and wherein said detector is configured to monitor said ring-down characteristic, said sensed substance modifying said cavity ring-down characteristic.

44. A sensor as claimed in claim 42 wherein a portion of said TIR surface to which said material is attached has substantially no features with a dimension perpendicular to said surface of greater than 1 μm.

45. A sensor as claimed in claim 42 wherein said functionalising material comprises a solvating medium to convert a gas-phase target to a solution at said TIR surface.

46. A sensor as claimed in claim 42 wherein said TIR surface is provided with a partition or atrium configured to allow selective transport of entities via said partition or atrium to or from said TIR surface.

47. A sensor as claimed in claim 46 wherein said partition or atrium is configured for application of a charge or potential to control said selective transport.

48. A sensor as claimed in claim 42 wherein said material includes a tether or link to attach the material to said surface.

49. A sensor as claimed in claim 42 wherein said material is directly attached to said TIR surface.

50. A sensor as claimed in claim 42 wherein said material provides fractional monolayer coverage of said TIR surface, wherein said fractional coverage is less than 10⁻¹.

51. A sensor as claimed in claim 50 wherein said fractional cover is less than 10⁻².

52. A sensor as claimed in claim 50 wherein parts of said TIR surface not covered by said material are passivated.

53. A sensor as claimed in claim 42 wherein said material comprises a crown ether or derivative thereof.

54. A sensor as claimed in claim 42 wherein said material comprises DNA or RNA attached to said TIR surface by one or more complementary base pairs.

55. A sensor as claimed in claim 42 wherein said material functionalising said surface comprises two components, one with an affinity or attraction for said target and a second to facilitate interaction with said evanescent wave.

56. A sensor for a cavity of an evanescent-wave optical sensing device, the sensor comprising a fibre optic cable having a core configured to guide light down the fibre surrounded by an outer cladding of lower refractive index than the core, wherein a sensing portion of the fibre optic cable is configured have a reduced thickness cladding provided with a functionalising material which has a selective response to a target such that an evanescent wave from said guided light interacts with said material and is modified by the presence of said target.

57. A sensor as claimed in claim 56 wherein said sensing portion of said fibre optic cable to which said functionalising material is attached has substantially no features with a dimension perpendicular to a surface of said sensing portion of greater than 3 μm.

58. A sensor as claimed in claim 56 wherein said functionalising material provides no more than substantially monolayer coverage of said sensing portion of said fibre optic cable.

59. A sensor as claimed in claim 56 wherein said sensing portion of said fibre optic cable is only partially covered by said functionalising material, and wherein parts of said sensing portion not covered by said functionalising material are passivated.

60. A sensor as claimed in claim 56 wherein said functionalising material includes a tether or link to attach the material to said sensing portion of said fibre optic.

61. A sensor as claimed in claim 56 wherein said functionalising material comprises a solvating medium to convert a gas-phase target to a solution at said sensing portion of said fibre optic.

62. A sensor as claimed in claim 56 wherein said sensing portion of said fibre optic is provided with a partition or atrium configured to allow selective transport of entities via said partition or atrium to or from said sensing portion.

63. A sensor as claimed in claim 56 wherein said sensing portion of said fibre optic cable provided with said functionalising material is configured to substantially inhibit scatter of said guided light.

64. A sensor as claimed in claim 56 wherein said optical sensing device comprises a cavity ring-down device

65. A sensor as claimed in claim 56 wherein said functionalising material comprises two components, one with an affinity or attraction for said target and a second to facilitate interaction with said evanescent wave.

66. An optical cavity-based gas-phase sensing device comprising:
an optical cavity absorption sensor comprising an optical cavity formed by a pair of reflecting surfaces;
a light source for providing light to couple into said cavity; and
a light detector for detecting a level of light escaping from said cavity;
wherein said optical cavity includes a sensing device comprising a functionalised optical interface, said optical interface being provided with a solvating medium to convert a gas-phase target to a solution at said interface.

67. A sensing device as claimed in claim 66 wherein said functionalised optical interface comprises two components, one with an affinity or attraction for said target and a second to facilitate interaction with said evanescent wave.

68. A sensing device including an optical interface to which is attached a material which has a selective response to a target such that an evanescent wave at said interface is modified by said target, said device further comprising a partition configured to allow selective transport of entities via said partition to or from said interface.

69. A sensing device as claimed in claim 68 wherein said partition is configured for application of a charge or potential to control said selective transport.

70. A sensing device as claimed in claim 68 wherein said entities are electrically charged.

71. A sensing device as recited in any claimed in claim 68 wherein said material comprises two components, one with an affinity or attraction for said target and a second to facilitate interaction with said evanescent wave.

72. A sensing device including an interface to which is attached a material which has a selective response to a target, wherein said interface is an optical interface, such that an evanescent wave at said interface is modified by said target, and wherein said interface is further provided with a photoelectron generator to assist in refreshing said interface.

73. A method of refreshing an interface to which is attached a material which has a selective response to a target, the method comprising:
providing said interface with a photoelectron generator; and
illuminating said photoelectron generator to release electrons to refresh said interface.

74. An optical charge/capacitance sensor for providing an optical signal responsive to charge and/or capacitance at an optical interface, said sensor comprising a light input and a light output and being configured to provide an optical path between said light input and said light output, said optical path including a totally internally reflecting (TIR) optical interface for attenuated TIR-based sensing, said TIR interface being treated such that a change in charge and/or capacitance at said interface causes a change in absorbance of light travelling between said light input and said light output.

75. A sensor as claimed in claim 74 wherein said interface treatment comprises partially providing said interface with light absorbing molecules.

76. A sensor as claimed in claim 74 wherein said interface comprises a silica interface.
